(19) United States
(12) Patent Application Publication
(10) Pub. No.: US 2025/0366491 A1
(43) Pub. Date: Dec. 4, 2025

(54) FUNCTIONAL PLANT PROTEINS AND METHODS FOR GENERATING SAME

(71) Applicant: MEALA FOODTECH LTD, Haifa (IL)

(72) Inventors: Hadar EKHOIZ RAZMOVICH, Givat Shapira (IL); Liran GRUDA, Haifa (IL); Tali FELDMAN SIVAN, Hadar Am (IL); Vered BEN YOSEF SHUSTER, Bustan HaGalil (IL); Oded HALEVI, Or-Akiva (IL)

(21) Appl. No.: 19/304,167

(22) Filed: Aug. 19, 2025

Related U.S. Application Data
(63) Continuation of application No. PCT/IL2024/050221, filed on Feb. 27, 2024.
(60) Provisional application No. 63/448,744, filed on Feb. 28, 2023.

(51) Int. Cl. A23J 3/14; A23D 7/005; A23J 3/16; A23J 3/34; A23P 30/40

(52) U.S. Cl. CPC A23J 3/14; A23D 7/0053; A23J 3/16; A23J 3/346; A23P 30/40

(57) ABSTRACT

The present invention provides compositions comprising modified plant-derived polypeptides, and at least one hydrolase and/or a crosslinking enzyme, which composition is capable of forming hydrogels, emulsions and foams, and methods for their preparation.

### CROSS REFERENCE TO RELATED APPLICATIONS

This application is a National Phase of PCT Patent Application No. PCT/IL2024/050221 having International filing date of Feb. 27, 2024, which claims the benefit of priority of U.S. Provisional Patent Application No. 63/448,744, filed Feb. 28, 2023, the contents of which are all incorporated herein by reference in their entirety.

### FIELD OF THE INVENTION

The present disclosure is generally directed to plant-based foods. Specifically, the invention relates to compositions comprising plant-derived protein and enzymes which may be at various consistencies such as gel, emulsion, and foam.

### BACKGROUND OF THE INVENTION

The food industry employs various types of colloids to achieve desired textures, functionality, stability, flavors, and appearances in different products. This includes emulsions, foams, suspensions, gels, sol, hydrocolloids, and micelles.

Hydrocolloids are among the most commonly used ingredients in the food industry. They function as thickeners, gelling agents, emulsifiers, stabilizers, fat replacers, clarifying agents, flocculating agents, clouding agents and whipping agents, encapsulating flavors and crystallization inhibition.

Hydrocolloids are a group of long chain polymers (polysaccharides and proteins) characterized by their property of forming viscous dispersions and/or gels when dispersed in water. Hydrocolloids can thus contribute to the viscosity and texture of food products.

Today, thickening effects are mainly provided by hydrocolloids one of the leading one is carboxymethyl cellulose (CMC), methyl cellulose and hydroxypropyl methyl cellulose.

Methylcellulose is a cellulose derivative used as a thickener, emulsifier, binder, stabilizer, and gelling agent in food and has the European food additive number E461. It is a water-soluble polymer chemically modified from natural cellulose by partial etherification. Methylcellulose forms a gel that gels upon heating above certain temperatures (generally, 42.5° C.) and returns to become a viscous solution after cooling down.

Therefore, using methylcellulose and other hydrocolloids in food products necessitates using additional food additives, such as stabilizers, taste maskers, etc. to perform their function properly and results in a bloated list of ingredients, which goes against the move to clean labeling.

Additionally, methylcellulose and its derivatives such as carboxymethylcellulose (CMC), while in use since the 1960, have been found to alter the gut microbiome, resulting in disease in the form of various chronic inflammatory conditions, including colitis, metabolic syndrome, and colon cancer.

Moreover, the food industry in general still faces several challenges when it comes to food products, that are tasty, clean label, healthy and have the right texture.

Therefore, there is a need to create better and more versatile food ingredients by developing healthier, clean label ingredients, thereby enabling the production of better products.

### SUMMARY OF INVENTION

The following embodiments and aspects thereof are described and illustrated in conjunction with compositions and methods which are meant to be exemplary and illustrative, not limiting in scope. In various embodiments, one or more of the above-described problems have been reduced or eliminated, while other embodiments are directed to other advantages or improvements.

In the present invention, the inventors have found that functional plant-based proteins that have superior binding, gelling and water holding capacity can be produced by methods of the invention, using enzymatic treatments, optionally in combination with physical treatment, while avoiding chemical treatments.

The functional proteins disclosed herein mimics and can therefore serve as a replacement to the long list of hydrocolloids typically used in the food industry (for example in plant-based meat products, baking products, frozen desserts, sauces, dressings and the like), thereby transforming these products from ultra-processed products into clean label, healthier and more sustainable products.

Advantageously, the herein disclosed composition provides standardized and improved functional properties of plant proteins despite originating from various plant sources, thus enabling straight forward downstream processing.

According to some embodiments, there is provided a composition comprising a plant protein extract comprising a plant-derived polypeptides, and at least one enzyme selected from an oxidoreductases, a crosslinking enzyme, a hydrolase, and any combination thereof. According to some embodiments, the composition comprises at least one cross-linking enzyme and at least one hydrolase. According to some embodiments, the composition comprises at least one hydrolase and is devoid of cross-linking enzyme.

According to some embodiments, one or more functional properties of the plant-derived polypeptides are standardized, such that plant-derived polypeptides of different origin exhibit essentially similar functional properties. A used herein, the term “essentially similar” with regards to functional properties refers to sufficiently similar to obtain a desired structure (e.g. strength, water capacity etc. of the hydrogel, foam or emulsion formed. According to some embodiments, the term “essentially similar” may refer to a variation of ±1%, ±5% or ±10% in a stated value. Each possibility is a separate embodiment.

According to some embodiments, the one or more functional properties are selected from thermal stability, surface, hydrophobicity, solubility, and emulsifying properties and any combination thereof. Each possibility is a separate embodiment.

According to some embodiments, the plant-derived polypeptides are at least partially crosslinked.

According to some embodiments, the plant-derived polypeptides are derived from soy, pea, corn, wheat, rice, nuts, almond, peanut, seitan, lentil, chickpea, flaxseed, chia seed, oat, buckwheat, bulgur, millet, sunflower, canola, legumes, pulses, tofu, tempeh, seitan, seeds, grain, chickpeas, lentils, legume, lupin, rapeseed, yeast, algae, microalgae, edamame, spelt, teff, hemp seeds, spirulina, amaranth, quinoa, leafy vegetables, oats, wild rice, chia seeds, fava bean, yellow pea, mung bean, nuts, protein-rich fruits and vegetables (such as broccoli, spinach, asparagus, artichokes, potatoes, sweet potatoes, brussels sprouts, sweet corn, guava, cherimoyas, mulberries, blackberries, nectarines, bananas), and combinations thereof. Each possibility is a separate embodiment.

According to some embodiments, the plant protein extract is a dry fractionation product.

According to some embodiments, the plant protein extract comprises about 50% to about 90%, about 50% to about 85%, or about 55% to about 80% by weight plant-derived polypeptides. Each possibility is a separate embodiment.

According to some embodiments, the composition comprises at least one oxidoreductase. According to some embodiments, the oxidoreductase is a multicopper enzyme capable of oxidating phenolic residues. According to some embodiments, the oxidoreductase is a laccase, a tyrosinase, a peroxidase, glucose oxidase, a glutathione oxidase or any combination thereof.

According to some embodiments, the composition comprises at least one cross-linking enzyme. According to some embodiments, the at least one crosslinking enzyme is a transferase or a peptidase. According to some embodiments, the transferase is an amino-acyltransferases, preferably a protein-glutamine gamma-glutamyltransferase. According to some embodiments, the peptidase is a cysteine endopeptidase. According to some embodiments, the cross-linking enzyme is an oxidoreductase.

According to some embodiments, the at least one enzyme comprises a hydrolase and/or isomerase. According to some embodiments, the hydrolase is glycosidase. According to some embodiments, the glycosidase is a pectinase, a pectinmethylesterase, an amylase, an invertase, a cellulase or any combination thereof. Each possibility is a separate embodiment. According to some embodiments, the hydrolase is a lipase. According to some embodiments, the lipase is selected from a phospholipase, a lysophospholipase, a galactolipase, a feruloyl esterase or any combination thereof. Each possibility is a separate embodiment. According to some embodiments, the isomerase is glucose isomerase.

According to some embodiments, the composition comprises at least one cross-linking enzyme and at least one hydrolase.

According to some embodiments, the composition comprises at least one cross-linking enzyme and at least one isomerase.

According to some embodiments, the composition comprises an oxidoreductase and a hydrolase.

According to some embodiments, the composition comprises an oxidoreductase, a crosslinking enzyme, and a hydrolase.

According to some embodiments, the composition comprises an oxidoreductase, a crosslinking enzyme, and a hydrolase.

According to some embodiments, use of isomerase may be particularly suitable for formation of foams and emulsions having a desired density, thickness and/or stability.

According to some embodiments, the ratio of the plant-derived polypeptides to the at least one enzyme is in a range of about 1:0.001 to about 1:0.2 by weight or 1:0.001 to about 1:0.007 by weight, or 1:0.001 to about 1:0.02 by weight, or 1:0.001 to about 1:0.06 by weight. Each possibility is a separate embodiment.

According to some embodiments, the enzyme is irreversibly inactivated. According to some embodiments, the enzyme is irreversibly inactivated by drying and/or freezing. According to some embodiments, the enzyme is reversibly inactivated by drying and/or freezing. According to some embodiments, the reversibly inactive enzyme is reactivatable by hydration and/or thawing.

According to some embodiments, the composition further comprises a mediator mediating crosslinking of the polypeptides. According to some embodiment, the mediator is not added externally. According to some embodiment, the mediator is a byproduct of a pretreatment (heating, sonication, applying pressure etc.) and/or of an enzymatic reaction.

According to some embodiments, the composition further comprises one or more cofactors, vitamins, minerals or combination thereof.

According to some embodiments, the composition is essentially devoid of methyl cellulose.

According to some embodiments, the composition is essentially devoid of animal derived proteins and/or fats.

According to some embodiments, the composition is thermoresistant.

According to some embodiments, the plant-derived polypeptides are comprised in a porous plant protein matrix.

According to some embodiments, the composition forms a hydrogel when hydrated.

According to some embodiments, the composition comprises active residues which upon rehydration enable crosslinking between the matrix and externally added polypeptides.

According to some embodiments, the composition further comprises at least one oil or fat. According to some embodiments, the at least one oil or fat is fat. According to some embodiments, the at least one oil or fat is selected from canola oil, olive oil, soy oil, sunflower oil, mustard powder oil, coconut oil, coconut fat, butter, and margarine. Each possibility is a separate embodiment.

According to some embodiments, the composition is in the form of a foam. According to some embodiments, the foam is devoid of externally added stabilizers.

According to some embodiments, the composition is in the form of an emulsion. According to some embodiments, the emulsion is devoid of externally added stabilizers.

According to some embodiments, there is provided a food product comprising the composition disclosed herein.

According to some embodiments, there is provided a composition comprising a porous plant protein matrix comprising crosslinked plant-derived polypeptides, and at least one enzyme selected from an oxidoreductase, a crosslinking enzyme, a hydrolase, and any combination thereof, wherein the matrix forms a hydrogel when hydrated.

According to some embodiments, there is provided a plant-based emulsion comprising a plant protein extract comprising crosslinked plant-derived polypeptides, at least one enzyme selected from an oxidoreductase, a crosslinking enzyme, a hydrolase, and any combination thereof, and at least one oil or fat, wherein the emulsion is essentially devoid of an external stabilizer.

According to some embodiments, there is provided a plant-based foam comprising a plant protein extract comprising crosslinked plant-derived polypeptides, and at least one enzyme selected from an oxidoreductase, a crosslinking enzyme, a hydrolase, and any combination thereof, wherein the foam is essentially devoid of an external, non-clean label, artificial and/or synthetic stabilizers.

According to some embodiments, there is provided a plant-based emulsion comprising a plant protein extract comprising crosslinked plant-derived polypeptides, and at least one enzyme selected from an oxidoreductase, a transferase enzyme, a hydrolase, and any combination thereof, wherein the foam is essentially devoid of an external, non-clean label, artificial and/or synthetic stabilizers, thickeners or other additive.

According to some embodiments, the emulsion and/or the foam include a hydrolase only.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not to scale.

In the Figures:

FIG. 1 illustratively depicts a process for production of the herein disclosed composition in accordance with some embodiments.

FIG. 2a is an exemplary flow diagram of a process for production of a hydrogel, in accordance with some embodiments.

FIG. 2b is an exemplary flow diagram of a process for production of a foam, in accordance with some embodiments.

FIG. 2c is an exemplary flow diagram of a process for production of an emulsion, in accordance with some embodiments.

FIG. 3 shows exemplary gel results analysis for hardness (N)—the highest peak force measured during first compression of the herein disclosed hydrogel (MP) as compared to methyl cellulose (MC). in accordance with some embodiments.

FIG. 4 shows exemplary gel results analysis for cohesiveness of the herein disclosed hydrogel (MP) as compared to methyl cellulose (MC). in accordance with some embodiments.

FIG. 5 shows exemplary gel results analysis for springiness of the herein disclosed hydrogel (MP) as compared to methyl cellulose (MC). in accordance with some embodiments.

FIG. 6 shows exemplary gel results analysis for gumminess of the herein disclosed hydrogel (MP) as compared to methyl cellulose (MC). in accordance with some embodiments.

FIG. 7 shows exemplary gel results analysis for chewiness of the herein disclosed hydrogel (MP) as compared to methyl cellulose (MC). in accordance with some embodiments.

FIG. 8 is a graph comparing the gel results analysis for hardness (N) of the herein disclosed pea-protein based hydrogel as compared to pea-based control (raw material, without enzymatic treatment).

FIG. 9 is a graph comparing the gel results analysis for hardness (N), of the herein disclosed hydrogel (MP) as compared to albumen, in accordance with some embodiments.

FIG. 10 is a graph comparing the gel results analysis for cohesiveness of the herein disclosed hydrogel (MP) as compared to albumen, in accordance with some embodiments.

FIG. 11 is a graph comparing the gel results analysis for gumminess of the herein disclosed hydrogel (MP) as compared to albumen, in accordance with some embodiments.

FIG. 12 is a graph comparing the gel results analysis for springiness of the herein disclosed hydrogel (MP) as compared to albumen, in accordance with some embodiments.

FIG. 13: Results of oscillatory frequency sweep test for pea protein-based gels. Diamonds: pea-based control; squares: pea-based composition from powder; circles: pea-based composition. Red: G′Pa; blue: G″Pa; Green: phase angle.

FIG. 14: Results of oscillatory frequency sweep test of soy protein-based gels. Diamonds: soy-based control; squares: soy-based composition 2; circles: soy-based composition 1; X: soy-based composition 3. Red: G′Pa; blue: G″Pa; Green: phase angle.

FIG. 15: Results of oscillatory frequency sweep test of pea protein-based gels demonstrating storage module. Diamonds: pea-based control; circles: pea-based composition; square pea-based composition from powder.

FIG. 16: Results of oscillatory frequency sweep test of pea-protein-based gels regarding phase angle. Diamonds: pea-based control; circles: pea-based composition; square: pea-based composition from powder.

FIG. 17: Results of oscillatory frequency sweep test of soy protein-based gels regarding storage module. Diamonds: soy-based control; circles: soy-based composition 1; square: soy-based composition 2; X: soy-based composition 3.

FIG. 18: Results of oscillatory amplitude sweep test of soy protein-based gels regarding storage module. Diamonds: soy-based control; circles: soy-based composition 1; X: soy-based composition 3.

FIG. 19: Results of oscillatory amplitude sweep test of soy-protein-based gels regarding Phase angle. Diamonds: soy-based control; circles: soy-based composition 1; X: soy-based composition 3.

FIG. 20: is a table comparing cooking yield percents of different plant-based protein (soy, pea, faba bean and red lentil) hydrogels, formed by using a concentrate and/or an isolate plant-based protein, and their exemplary before and after cooking photos.

FIG. 21: is a bar graph comparing the cooking yield percents of various plant protein-based hydrogels, formed by using a concentrate and/or an isolate plant-based protein (soy, pea, faba bean and red lentil) obtained from different suppliers (1-8).

FIG. 22: Results of oscillatory amplitude sweep test for soy protein-based emulsions. Circles: soy-protein-and sunflower oil-based emulsion, prepared as disclosed herein; squares: soy protein-and sunflower oil-based-control emulsion (without enzymatic treatment). Red: G′Pa; blue: G″Pa.

FIG. 23: Results of oscillatory amplitude sweep test for soy protein-and coconut fat-based emulsions. Circles: soy-based emulsion including coconut fat, prepared as disclosed herein; squares: soy protein and coconut fat-based control emulsion (without enzymatic treatment). Red: G′Pa; blue: G″Pa.

FIG. 24: Results of oscillatory amplitude sweep test for pea protein-and sunflower oil-based emulsions. Circles: pea-protein emulsion including sunflower oil, prepared as disclosed herein; squares: pea protein-and sunflower oil-based control emulsion (without enzymatic treatment). Red: G′Pa; blue: G″Pa.

FIG. 25: Results of oscillatory amplitude sweep test for pea protein-and coconut fat-based emulsions. Circles: pea-based emulsion including coconut fat, prepared as disclosed herein; squares: pea protein-and coconut fat-based control emulsion (without enzymatic treatment). Red: G′Pa; blue: G″Pa; Green.

FIG. 26: Results of oscillatory amplitude sweep test of soy protein and sunflower oil, based emulsions regarding Phase angle (green). Squares: soy protein and sunflower oil-based control emulsion (without enzymatic treatment); circles: soy-based and sunflower composition, prepared as disclosed herein.

FIG. 27: Results of oscillatory amplitude sweep test of soy protein-and coconut fat-based emulsions regarding Phase angle (green). Squares: soy protein-and coconut fat-based control emulsion (without enzymatic treatment); circles: soy protein-and coconut fat-based composition, prepared as disclosed herein.

FIG. 28: Results of oscillatory amplitude sweep test of pea protein and sunflower oil-based emulsions regarding Phase angle (green). Squares: pea protein and sunflower oil-based control emulsion (without enzymatic treatment); circles: pea-based and sunflower composition, prepared as disclosed herein.

FIG. 29: Results of oscillatory amplitude sweep test of pea protein-and coconut fat-based emulsions regarding Phase angle (green). Squares: pea protein-and coconut fat-based control emulsion (without enzymatic treatment); circles: pea protein-and coconut fat-based composition, prepared as disclosed herein.

FIG. 30: A) Exemplary photo of a pea protein and sunflower oil-based emulsion with enzymatic treatment, as disclosed herein A1, or control pea protein and sunflower oil-based emulsion prepared without enzymatic treatment A2; B) Exemplary photo of a pea protein and coconut fat-based emulsion with enzymatic treatment, as disclosed herein B1, or control pea protein and coconut fat-based emulsion prepared without enzymatic treatment B2.

FIG. 31: is exemplary photos of the herein disclosed pea protein and coconut fat-based emulsion from powder (about 20% w/w fat) as compared to commercial pea protein and coconut fat-based control emulsion (without enzymatic treatment) (about 20% w/w fat), taken after 20 and 96 hours at 4° C.

FIG. 32A-32B: is exemplary photos of the herein disclosed pea protein and sunflower oil-based emulsion from powder (about 60% w/w oil) (B) as compared to commercial pea protein and sunflower oil-based control emulsion (without enzymatic treatment) (about 60% w/w oil) (A).

FIG. 33: is exemplary photos of the herein disclosed pea protein-based foam from powder, at T=0, 15 and 30 minutes at room temperature, as compared to albumen-based foam and commercial pea protein-based control foam (without enzymatic material).

### DETAILED DESCRIPTION OF THE INVENTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

Unless otherwise defined, all technical and scientific terms used herein have the same meaning as commonly understood by one of ordinary skill in the art to which this disclosure pertains.

In case of conflict, the patent specification, including definitions, governs. As used herein, the indefinite articles “a” and “an” mean “at least one” or “one or more” unless the context clearly dictates otherwise.

The term “about” when referring to a measurable value such as an amount, a ratio, and the like, is meant to encompass variations of ±10% of the indicated value, as such variations are also suitable to perform the disclosed invention. Any numerical values appearing in the application are intended to be construed as if preceded by “about”, unless indicated otherwise.

In the description and claims of the application, the words “include” and “have”, and forms thereof, are not limited to members in a list with which the words may be associated.

The present invention is based on the surprising finding that compositions prepared from plant-based materials and treated by enzymes according to the invention give rise to crosslinked plant-based products, which can further be used for preparing stable hydrogels, emulsions and foams.

According to some embodiments, there is provided a composition comprising a plant protein extract comprising plant-derived polypeptides, and at least one enzyme selected from an enzyme oxidoreductase, an enzyme forming peptide bonds (e.g. iso-peptide bonds) between amino acid residues, a hydrolase, and any combination thereof.

According to some embodiments, there is provided a composition comprising a plant protein extract comprising plant-derived polypeptides and at least one enzyme selected from an enzyme oxidoreductase, and/or a hydrolase. Each possibility is a separate embodiment.

According to some embodiments, the enzyme capable of forming iso-peptide/peptide bonds between amino acid residues is a crosslinking enzyme. An iso-peptide bond is a peptide bond formed between a carboxyl group and an amino group of joining amino acids, where at least one of them is part of the side chain. It may also form between the gamma-carboxamide group of glutamines and the primary amine of certain amino acids. According to some embodiments, the crosslinking enzyme is an oxidoreductase. According to some embodiments, the crosslinking enzyme is a transferase.

Accordingly, in some embodiments, there is provided a composition comprising a plant protein extract comprising plant-derived polypeptides, and at least one enzyme selected from an oxidoreductase, a crosslinking enzyme, a hydrolase, and any combination thereof.

According to some embodiments, the plant protein extract comprises at least partially crosslinked plant-derived polypeptides. According to some embodiments, the plant protein extract comprises completely crosslinked plant-derived polypeptides.

As used herein, the term “plant-derived” refers to material made from a plant, wherein the plant may be a fungus, cactus, herbaceous plant, flowering plant, food crop plant, and/or combinations thereof. For example, the plant-derived material may be made from or extracted from any part of a plant, such as a root, stem, leaf, seed, flower, fruit plant, and/or combinations thereof. According to some embodiments, the term “derived” may be substituted with the term “isolated” or “based”. Also, the term “plant protein” is used interchangeably with “plant-derived protein”.

As used herein, the term “polypeptide” refers to a continuous, unbranched chain of amino acids joined by peptide bonds. A peptide consisting of two or more amino acids. Peptides differ from polypeptides in that they are made up of shorter chains of amino acids (at least 10 amino acids). Amino acids make up polypeptides which, in turn, make up proteins. For example, amalin, glucagon, etc.

As used herein, the term “protein” refers to long chains of amino acids held together by peptide bonds, a protein may contain one or more polypeptides. For example, amylase, lipase, pepsin, hemoglobin, insulin, tubulin, keratin, etc. A protein may be a polypeptide. However, the term protein also encompasses proteins which include post-translation modifications, such as by adding glycosylation, acylation, alkylation, hydroxylation, amidation, oxidation, phosphorylation, etc.

According to some embodiments, the composition comprises at least one plant-derived protein. According to some embodiments, the composition comprises at least one plant-derived polypeptide.

The terms “plant protein extract”, “modified polypeptides”, “modified proteins” and “functional proteins” may be used interchangeably and refer to the plant material used in the invention, which includes plant-derived proteins or polypeptides and other plant-derived components such as carbohydrates, fats, etc. According to some embodiments, the terms refer to proteins that have been enzymatically treated. According to some embodiments, the terms refer to proteins that have been preprocessed (e.g. by heating, pressure and the like), to unfold chains and/or expose internal sulfhydryl groups, hydrophobic side chains, and/or any other previously buried active sites, and subsequently enzymatically treated. According to some embodiments, the plant extract includes solely components derived from plant.

According to some embodiments, the composition is a functional protein powder.

The term “functional powder” refers to a protein powder that (as a result of the herein disclosed enzymatic and/or physical treatment) have an improved binding, gelling and/or water holding capacity as compared to its untreated protein powders. Each possibility is a separate embodiment.

The term “clean-label” refers to products including ingredients that are understandable, that are easy to recognize without being a food scientist, and that are considered healthy.

The term “plant-derived polypeptide” is used herein interchangeably with “plant-based polypeptide”, “plant protein” or “plant polypeptide” and refers to the fraction of the protein and/or polypeptides in the plant protein extract, and respectively, the weight of the plant-derived polypeptide is the dry weight of the proteins in the plant protein extract.

According to some embodiments, the plant protein extract is a plant protein concentrate, a plant protein isolate, a plant-derived flour, or a combination thereof.

According to some embodiments, the plant protein extract is prepared by any method suitable for extracting proteins from plants. In some embodiments, the plant protein extract is prepared by dry fractionation. In some embodiments, the plant protein extract is prepared by wet fractionation. According to some embodiments, the plant protein extract is a dry fractionation product.

As used herein, the term “dry fractionation” refers to the classification of flour into different particles size and the chemical composition after milling. It depends upon the potentiality of milling to segregate protein bodies and other cellular components into different particle sizes. Advantageously, dry fractionation enables producing enriched fractions with retained (native) functionality. Moreover, dry fractionation considered more sustainable than wet fractionation because it requires less energy and water and does not need a drying process or the addition of chemicals.

As used herein, the term “wet fractionation” refers to production of protein isolates and concentrates in which the starting material is reduced in size and subsequently diluted to achieve complete disentanglement of the tissue structures to allow extraction of individual or classes of components (e.g., proteins, starch, and lipids).

Wet fractionation often involves the following steps: 1) preparation of a flour suspension, 2) extraction under alkaline or acidic conditions, 3) isoelectric precipitation or ultrafiltration, and 4) (spray) drying. Wet fractionation processes have the advantage that relatively pure (>90%) isolates can be obtained.

As used herein, the term plant “protein isolate”, refers to proteins extracted from plants by various methods such as isoelectric precipitation separation and ultrafiltration to obtain a highly concentrated protein fraction. The protein isolate typically includes at least 80% or at least 90% w/w plant proteins. Each possibility is a separate embodiment.

As used herein, the term plant “protein concentrate”, refers to proteins extracted from plants but without the additional processing steps of reducing fat and carbohydrate content carried out to obtain a protein isolate, the proteins per scoop is therefore lower in a protein isolate. The protein concentrates typically include 40-80% w/w plant proteins, such as about 40% w/w, about 50% w/w, about 60% w/w, about 70% w/w or about 75 w/w plant proteins. Each possibility is a separate embodiment.

As used herein, the term plant “protein flour” refers to flours obtained from plants with high protein content. Protein rich flour typically include 10-50% or 12-40% w/w plant proteins, such as about 10% w/w, about 12% w/w, about 15% w/w, about 20% w/w, about 25% w/w or plant proteins. Each possibility is a separate embodiment. Non-limiting examples of protein rich flours include chickpea flour (˜22%), coconut flour (˜20%), peanut flour (˜34%), red lentil flour (26%), sesame flour (˜40%), soy flour (˜38%), sunflower seed flour (˜48%), almond flour (˜21%).

According to some embodiments, the composition when dried to a powder comprises at least 50% w/w, 60% w/w 70% w/w, 80% w/w, at least 85% w/w, at least 90% or at least 95% plant protein extract.

According to some embodiments, the plant protein extract comprises 90% or less, 85% w/w or less, 80% w/w or less, 75% w/w or less, 70% w/w or less, 65% w/w or less, or 60% w/w or less, plant-derived polypeptides.

According to some embodiments, the plant protein extract comprises between about 50 and about 90% w/w, between about 50 and about 85% w/w, between about 70 and about 90% w/w, or between about 60 and about 80% w/w plant-derived polypeptides.

According to some embodiments, the plant protein or polypeptide is derived from pea, corn, wheat, rice, nuts, almond, peanut, seitan, lentil, chickpea, flaxseed, chia seed, oat, buckwheat, bulgur, millet, sunflower, canola, legumes, pulses, tofu, soy, tempeh, seitan, seeds, grain, chickpeas, lentils, legume, lupin, rapeseed, yeast, algae, microalgae, edamame, spelt, teff, hemp seeds, spirulina, amaranth, quinoa, leafy vegetables, oats, rice, wild rice, chia seeds, fava bean, yellow pea, mung bean, nuts, protein-rich fruits and vegetables (such as broccoli, spinach, asparagus, artichokes, potatoes, sweet potatoes, brussels sprouts, sweet corn, guava, cherimoyas, mulberries, blackberries, nectarines, bananas, etc.) or any combination thereof. Each possibility is a separate embodiment.

According to some embodiments, the plant-based polypeptide is derived from pea. According to some embodiments, the plant-based polypeptide is derived from soy. According to some embodiments, the plant-based polypeptide is derived from faba bean. According to some embodiments, the plant-based polypeptide is derived from red lentils.

According to some embodiments, the plant-derived polypeptide is derived from more than one plant source, such as, but not limited to soy and chickpea, pea and sunflower, soy and pea tofu, canola and chia seeds etc.

According to some embodiments, the plant-derived polypeptide is derived from more than one type of protein sources, such as, but not limited to protein flour and isolated protein, isolated proteins and protein concentrate, protein concentrate and protein flour or protein flour and protein concentrate and protein isolate at various ratios.

According to some embodiments, the plant protein is selected from leghemoglobin, non-symbiotic hemoglobin, hemoglobin, myoglobin, chlorocruorin, erythrocruorin, neuroglobin, cytoglobin, protoglobin, truncated 2/2 globin, HbN, cyanoglobin, HbO, Glb3, and cytochromes, Hell's gate globin I, bacterial hemoglobins, ciliate myoglobins, flavohemoglobins, ribosomal proteins, actin, hexokinase, lactate dehydrogenase, fructose bisphosphate aldolase, phosphofructokinases, triose phosphate isomerases, phosphoglycerate kinases, phosphoglycerate mutases, enolases, pyruvate kinases, glyceraldehyde-3-phosphate dehydrogenases, pyruvate, decarboxylases, actins, translation elongation factors, ribulose-1,5-bisphosphate carboxylase oxygenase (rubisco), ribulose-1,5-bisphosphate carboxylase oxygenase activase (rubisco activase), albumins, glycinins, conglycinins, globulins, vicilins, conalbumin, gliadin, glutelin, gluten, glutenin, hordein, prolamin, phaseolin (protein), proteinoplast, secalin, extensins, triticeae gluten, zein, any seed storage protein, oleosins, caloleosins, steroleosins or other oil body proteins, vegetative storage protein A, vegetative storage protein B, moong seed storage 8S globulin, etc., or derivatives thereof. Each possibility is a separate embodiment.

According to some embodiments, the one or more plant proteins are completely crosslinked in the composition. According to some embodiments, the one or more plant proteins are semi-crosslinked, or partially crosslinked. According to some embodiments, the functional properties of plant-derived polypeptides are altered by modifying the natural crosslinks. According to some embodiments, the functional properties of plant-derived polypeptides are altered by introducing new crosslinks into the structure of the polypeptide. Optionally, crosslinking is due to peptide bonds between amino acid residues. Optionally, crosslinking is due to treatment with an oxidoreductase.

In some embodiments, the at least one enzyme comprises an oxidoreductase. According to some embodiments the at least one oxidoreductase comprises a mixture of enzymes (e.g. 2, 3, 4) oxidoreductases. In some embodiments, the at least one enzyme comprises at least one enzyme capable of forming peptide bonds or iso-peptide bonds. According to some embodiments the at least one enzyme capable of forming peptide bonds comprises a mixture of enzymes (e.g. 2, 3, 4) capable of forming peptide bonds. In some embodiments, the at least one enzyme comprises at least one hydrolase. In some embodiments, the at least one enzyme comprises at least one isomerase (EC 5.x). According to some embodiments the at least one hydrolase comprises a mixture (e.g. 2, 3, 4) of hydrolases.

According to some embodiments, the composition comprises at least one oxidoreductase and at least one enzyme capable of forming peptide/iso-peptides bonds. According to some embodiments, the composition comprises at least one oxidoreductase and at least one hydrolase. According to some embodiments, the composition comprises at least one enzyme capable of forming peptide/iso-peptides bonds and at least one hydrolase. According to some embodiments, the composition comprises least one oxidoreductase, at least one enzyme capable of forming peptide bonds, and at least one hydrolase.

It is understood that as used herein, the term “capable of” refers to the property of the enzyme and not to its activation state (activated/inactivated). For example, an enzyme capable of forming peptide bonds refers to an enzyme having the property of forming peptide bonds whether or not the enzyme in the composition is in an active or deactivated state.

In some embodiments, the at least one crosslinking enzyme is an oxidoreductase and/or a transferase.

In some embodiments, the at least one enzyme comprises at least one enzyme from the oxidoreductase family, at least one crosslinking enzyme, and at least one hydrolase. In some embodiments, the at least one enzyme comprises at least two of an oxidoreductase, a crosslinking enzyme, and a hydrolase.

As used herein, the term “enzyme” refers to a biological catalyst which speeds up the rate of a specific chemical reaction in an organism and is almost always a protein. Non-limiting examples of enzymes that may be utilized include transglutaminase (TG, EC 2.3.2.13), pectinmethylesterase (PME, EC 3.1.1.11), laccase (EC 1.10.3.2), amylase (EC 3.2.1.X), cellulases (EC 3.2.1.4), lipase (EC 3.1.1.X), invertase (EC 3.2.1.26), tyrosinase (EC 1.14.18.1), oxidoreductase, peroxidase (EC 1.11.1.X), sulfhydryl oxidase glutathione oxidase (EC 1.8.3.3), sortase A (EC3.4.22.70), pectin lyase (EC 4.2.2.10), polygalacturonase (EC 3.2.1.15), Glucose oxidase (EC 1.1.3.4), Glucose isomerase (EC 5.3.1.5), transferase (EC 2.1 to EC 2.10), hydrolase (EC 3.1 to EC 3.13), an amino acid oxidase (EC 1.4.3.x), and any combination thereof. Each possibility is a separate embodiment.

According to some embodiments, the protein is activated by exposing buried active functional amino acids residues. According to some embodiments, the exposure of the buried residues results in spontaneous reactions with other components in the protein extract, such as carbohydrates. According to some embodiments, the amino acids undergo enzymatic crosslinking using a combination of enzymes and process. According to some embodiments, the exposing buried active functional amino acids residues and/or enzymatic crosslinking results in a semi-activated protein. According to some embodiments, the enzymatic treatment is not a protein degrading treatment. According to some embodiments, the enzymatically treated proteins essentially retain their structure (primary and/or secondary) and/or conformation,.

The term “semi-activated protein” or “semi-activated polypeptide” relates to a crosslinked protein in which some of the functional residues are free, and further processing or enzymatic treatment may lead to increased functionality. According to some embodiments, the semi-activated polypeptide can later still react with components if food products to which they are added.

Certain enzyme families are known for their crosslinking abilities and are considered a natural ingredient or processing aid. According to some embodiments, using multiple enzymes may allow for an overall improved flavor by eliminating compounds that may cause aftertaste. According to some embodiments, the enzymes may be Generally Recognized as Safe (GRAS) substances.

According to some embodiments, using multiple enzymatic groups simultaneously may lower the required concentration of each of them. Accordingly, the effect of using multiple enzymatic groups simultaneously may provide a synergistic effect in terms of crosslinking capabilities and/or in terms of achieving the desired hardness, springiness, chewiness and/or cohesiveness. Furthermore, using multiple enzymatic groups may reduce the overall production cost. Therefore, using different enzymatic groups enables to achieve a desired structural stability and a similar texture to that found in animal products. Using an enzyme mixture, the texture that the raw material gives the final product may be modified and adapted by demand.

According to some embodiments, the herein disclosed hydrogels have an improved cooking yield. According to some embodiments, the herein disclosed hydrogels have a cooking yield of at least 70%, at least 75%, at least 80% or at least 85%. Each possibility is a separate embodiment. According to some embodiments, the herein disclosed hydrogels have a cooking yield of 80-100% or 80-99% or 85-99%. Each possibility is a separate embodiment.

According to some embodiments, using multiple enzymes in the production process provides the ability to introduce new functionalities, such as protein-pectin bonds. Addition of protein-pectin bonds may improve textural stability, increasing water retention capacity and gelation properties.

According to some embodiments, the ratio of the plant-derived polypeptides to the at least one enzyme is in a range of 1:0.001-1:0.2, 1:0.005-1:0.2, 1:0.005-1:0.1, 1:0.005-1:0.05, 1:0.005-1:0.01, 1:0.01-1:0.2, 1:0.01-1:0.1, 1:0.01-1:0.05, 1:0.02-1:0.2, 1:0.02-1:0.1, 1:0.001-1:0.01, 1:0.001-0.005 or 1:0.02-1:0.05. Each possibility is a separate embodiment.

In some embodiments, each enzyme is used in the herein disclosed functional protein composition at a concentration in the form of a powder of up to about 0.1% w/w, up to about 0.25% w/w, up to about 0.5% w/w, up to about 1% w/w, up to about 2%, up to about 4%, between about 0.1% and about 2%, between about 0.1% and about 1%, or between about 0.2% and about 0.5%. Each possibility is a separate embodiment.

The use of enzymes in highly viscous reactions has proven to be problematic. As viscosity increases, enzymatic activity decreases. Every enzyme used increases the mixture's viscosity, which theoretically should inhibit the use of additional enzymes. However, according to some embodiments, adjusting the reaction conditions enables use of multiple enzymatic groups to produce stable products with strong protein connections and a high water-retention capability, contributing to achieving good texture. Without being bound by theory, this may be achieved for example, by adding at least the cross-linking enzymes before the maximum viscosity is reached, the addition of the crosslinking enzymes may lead to an additional increase in the viscosity.

According to some embodiments, certain ratios between enzymes such as hydrolases (e.g., pectinmethylesterase, cellulases, amylases, etc.) which decrease viscosity, and crosslinking enzymes which increase the viscosity, will result in an optimal result. In some embodiments, the enzymes are immobilized.

According to some embodiments, creating a combined matrix by using more than one enzymatic group results in the production of texture and juiciness similar to those produced by animal proteins. Non-limiting examples of food products which may make use of the composition include Mayonnaise, ice cream, bakery products, yeast dough, meat or fish alternative, egg alternative, dairy substitutes, pasta, marshmallow etc.

According to some embodiments, exposing buried amino acids in a protein and/or polypeptide with a unique composition of enzymes and processes produces ready to use protein optionally having a porous structure. According to some embodiments, the presence and/or accessibility of target amino acid side chains depends on the conformation of the substrate polypeptide and/or protein, which may be an important factor affecting formation of intermolecular and/or intramolecular crosslinks in polypeptides and/or proteins.

According to some embodiments, crosslinking may be performed by at least one oxidoreductase.

According to some embodiments, the oxidoreductase may be a multi-copper enzyme capable of oxidating phenolic residues. According to some embodiments, a multi-copper enzyme may catalyze oxidation of a wide variety of phenolic compounds by a single electron removal mechanism, which results in the formation of free radicals with concomitant reduction of molecular oxygen to water. According to some embodiments, the oxidoreductase may use H2O2 as an electron acceptor to oxidize a variety of organic and inorganic substrates, such as phenols, as a result of oxidation, a radical is formed that can react further with other substrates.

According to some embodiments, the oxidoreductase may be a laccase, a tyrosinase, a peroxidase, a glutathione oxidase, glucose oxidase or any combination thereof.

According to some embodiments, crosslinking is performed by at least one enzyme capable of forming peptide bonds between amino acid residues, or a crosslinking enzyme. For example, the enzyme may accelerate the formation of isopeptide bonds (a peptide bond formed between a carboxyl group of one amino acid and an amino group of another) between the side chains of glutamine residues and the side chains of lysine residues, thus enabling the formation of stable structures.

According to some embodiments, the at least one crosslinking enzyme is a transferase (EC 2.x) or an oxidoreductases (EC 1.x). According to some embodiments, the transferase is an amino-acyltransferases, such as a protein-glutamine gamma-glutamyltransferase. According to some embodiments, the peptidase is a cysteine endopeptidase.

According to some embodiments, the at least one oxidoreductases, the at least one crosslinking enzyme, and/or the at least one hydrolase, are reversibly inactivated by drying and/or freezing. According to some embodiments, the reversibly inactive enzyme is reactivated upon hydration and/or thawing.

According to some embodiments, the hydrolase is an enzyme capable of hydrolyzing polysaccharides. According to some embodiments, the hydrolase is a lipase.

Therefore, according to some embodiments, the hydrolase is an enzyme capable of hydrolyzing polysaccharides, or a glycosidase. According to some embodiments, the glycosidase is a pectinase (EC 3.2.x.x), an amylase (EC 3.2.1.1), a cellulase (EC 3.2.1.4) an invertase (EC 3.2.1.26) or any combination thereof. According to some embodiments, the pectinase is selected from the group including pectolyase, pectozyme, and/or polygalacturona.

According to some embodiments, the hydrolase is an enzyme capable of acting on ester bonds. According to some embodiments, the hydrolase is a carboxylic-ester hydrolases (EC 3.1.1). According to some embodiments, the hydrolase is a pectinestrase (3.1.1.11).

According to some embodiments, the hydrolase is a lipase. According to some embodiments, the lipase is selected from a phospholipase (E.C. 3.1.1.4), a lysophospholipase (EC: 3.1.1.5), a galactolipase (EC 3.1.1.26), a feruloyl esterase (EC 3.1.1.73) or any combination thereof. According to some embodiments, the lipase has a high selectivity toward transesterification/esterification/hydrolysis of saturated fatty acids, mono, di-and tri-unsaturated fatty acids, as free fatty acids and/or in the form of fatty acyl groups, and low selectivity toward the transesterification/esterification/hydrolysis of n-3 fatty acids as free fatty acids or as fatty acyl groups. Addition of a lipase may produce free fatty acids which may affect the flavor, aroma and/or the shelf life of the various food products produced.

According to some embodiments, the isomerase is an enzyme capable to transform a molecule into a different isomer. According to some embodiments, the isomerase is a glucose isomerase (which transforms glucose into fructose). According to some embodiments, the isomerase may be used in foams and emulsions. According to some embodiments, the isomerase may be used instead of or in addition to the hydrolase.

According to some embodiments, the plant protein extract includes a mediator mediating crosslinking of the polypeptides. According to some embodiments, the mediator is externally added. According to some embodiments, the mediator is not externally added.

According to some embodiments, the mediator is a small molecule which is readily oxidized by enzymes, such as laccase, to produce radicals which will then react with a target substrate. In some embodiments, the unique enzyme composition enables generation of mediators which penetrate the exposed active site and assist the crosslinking enzymes. In some embodiments, the mediator is a phenolic compound, such as monophenols, diphenols, etc. In some embodiments, the phenolic mediator is from sugar beet pectin (SBP) source (e.g., ferulic acid). In some embodiments, the mediator is selected from vanillin, vanillic acid, caffeic acid, and catechin. Each possibility is a separate embodiment.

In some embodiments, the mediator is generated in the composition by the activity of the enzymes, and is not externally added.

According to some embodiments, the composition includes one or more cofactor, vitamin, mineral and/or combination thereof.

According to some embodiments, the cofactor is a non-protein chemical compound or metallic ion required for an enzyme's role as a catalyst. Cofactors may be divided into two types: inorganic ions and complex organic molecules called coenzymes. In some embodiments, coenzymes are derived from vitamins and/or other organic essential nutrients in small amounts. In some embodiments, the cofactor is selected from flavin, heme, thiamine, folic acid, metal ions such as iron, magnesium, manganese, cobalt, copper, zinc, and molybdenum, iron-sulfur clusters, etc., and combinations thereof.

According to some embodiments, the vitamin is an organic compound that is essential for biological activity. In some embodiments, the vitamin is selected from vitamin A, vitamin C, vitamin D, vitamin E, vitamin K, choline, and B vitamins (thiamin, riboflavin, niacin, pantothenic acid, biotin, vitamin B6, vitamin B12, and folate/folic acid), etc., and combinations thereof.

According to some embodiments, the mineral is a macromineral and/or a trace mineral. According to some embodiments, the macromineral is selected from calcium, phosphorus, magnesium, sodium, potassium, chloride, sulfur, etc. and/or combinations thereof. Optionally, a trace mineral may be selected from the group including iron, manganese, copper, iodine, zinc, cobalt, fluoride, selenium etc. and/or combinations thereof.

According to some embodiments, the composition comprises about 0.02 to about 0.08% w/w salt. According to some embodiments, the salt is added by admixing. According to some embodiments, the salt is selected from sodium chloride, or any other sodium salts, potassium salts, calcium salts, magnesium salts, sodium citrate and a combination thereof. Each possibility is a separate embodiment.

According to some embodiments, the salt serves as a cofactor for the enzymes.

According to some embodiments, the composition further comprises polysaccharides such as pectin (e.g., fibers from rose hip, pear, apple, guava, quince, plum, gooseberry, citrus fruit, etc.), for the formation of safe and nontoxic hydrogel materials. According to some embodiments, the pectin in the final product undergoes extrusion and addition to plant-based protein. According to some embodiments, protein-pectin binding produces a stable form that improves water retention and/or gel formation. According to some embodiments, protein-pectin binding improves the texture and/or taste of a plant-based product.

According to some embodiments, the composition comprises semi-activated plant-derived polypeptides. According to some embodiments, the semi-activated plant-derived polypeptides are ready to use on the production line, thereby providing shorter production time. According to some embodiments, the semi-activated plant-derived polypeptides are combined with additional compounds for use in a food product (e.g., additional protein, cofactors, vitamins, minerals, enzymes, sugars, starch, fats, fiber, (e.g., fibers from rose hip, pear, apple, guava, quince, plum, gooseberry, citrus fruit, etc., etc.), etc. or any combination thereof). According to some embodiments, the semi-activated plant-derived polypeptides constitute a homogeneous mass. According to some embodiments, the semi-activated plant-derived polypeptides have widespread industry usage (e.g., not limited to only one or two types of protein).

In some embodiments, the composition is essentially devoid of animal-derived material. In some embodiments, the composition is essentially devoid of animal-derived proteins and/or fats.

According to some embodiments, the composition is essentially devoid of methylcellulose and other synthetic gelling agents.

In some embodiments, the composition is essentially devoid of an external stabilizer. As used herein, the term “essentially devoid of stabilizers” refers to compositions in which the stability is not obtained by adding an external, non-clean label stabilizer and/or a synthetic stabilizer.

This is due to the special process of the invention, which exposes buried functional residues as well as degrades carbohydrates, thereby providing internal stabilizers such as carbohydrates and peroxides.

The phrase “essentially devoid of”, as used herein with reference to an excluded substance, such as an external stabilizer, or methylcellulose, is intended to indicate the lack of the excluded substance. It is however conceivable that trace amounts of the excluded substance are still present. Nevertheless, such trace elements are not sufficient to carry out the function of the excluded substance, e.g. stabilize the composition.

The term “external stabilizer” relates to an added stabilizer which is not an inherent part of the plant material. According to some embodiments, the term stabilizer does not encompass ingredients such as fibers, sugars, fillers and other bulk ingredients. Examples for external stabilizers include methylcellulose.

According to some embodiments, the composition is in the form of a powder, a solid, a foam, an emulsion, a hydrogel, or a mixture thereof. According to some embodiments, the composition is in the form a hydrogel. According to some embodiments, the composition is in the form an emulsion. According to some embodiments, the composition is in the form of a foam.

According to some embodiments, the composition in the form of a powder comprises about 50-99% w/w treated polypeptides, about 40-95% w/w treated polypeptides, about 60-90% w/w treated polypeptides, about 50-90% w/w treated polypeptides, or about 40-85% w/w treated polypeptides or any range between these ranges. Each possibility is a separate embodiment.

According to some embodiments, the hydrogel comprises about 5-50% w/w treated polypeptides, about 10-25% w/w treated polypeptides, about 10-20% w/w treated polypeptides, or about 3-40% w/w treated polypeptides or any range between these ranges. Each possibility is a separate embodiment.

According to some embodiments, the emulsion comprises about 3-50% w/w treated polypeptides, about 5-25% w/w treated polypeptides, about 10-50% w/w treated polypeptides, about 5-20% w/w treated polypeptides, or about 10-17% w/w treated polypeptides or any range between these ranges. Each possibility is a separate embodiment.

According to some embodiments, the foam comprises about 3-40% w/w treated polypeptides, about 5-50% w/w treated polypeptides, about 5-30% w/w treated polypeptides, about 5-20% w/w treated polypeptides, or about 5-15% w/w treated polypeptides or any range between these ranges. Each possibility is a separate embodiment.

According to some embodiments, the herein disclosed composition comprises less free amino acid residues than untreated composition from a same protein source. According to some embodiments, the herein disclosed composition comprises shorter polysaccharide chains as compared to an untreated composition from a same protein source.

According to some embodiments, the one at least one enzyme crosslinks the plant-derived polypeptides. According to some embodiments, the crosslinked plant-derived polypeptides give rise to a porous plant protein matrix. Accordingly, in some embodiments, the composition comprises a porous plant protein matrix.

In some embodiments, the porous plant protein matrix is a hydrogel or forms a hydrogel when hydrated.

As used herein, the terms “hydrogel” and “hydrocolloid” may be used interchangeably and refer to a water-insoluble, three-dimensional (3D) network of hydrophilic polymers that can swell in water and hold a large amount of water, while maintaining the structure due to chemical or physical crosslinking of individual polymer chains. Examples for hydrogels include gelatin, collogen, alginate etc.

As used herein, the term “hydrated” refers to chemically combining a substance with water in its molecular form. Hydration involves the addition of water from a molecule, ion or substance. Dehydration involves the removal or loss of water from a molecule, ion or substance. Rehydration involves the return of water to a dehydrated molecule, ion or substance.

Hydrogels allow for water retention and crosslinking since a hydrogel is a three-dimensional (3D) network of hydrophilic polymers that swell in water and hold a large amount of water, while maintaining their structure, due to chemical or physical crosslinking of individual polymer chains. Hydrogels are currently mainly used in biomedical applications and are mostly made by synthetic processes. According to some embodiments, the herein disclosed plant-based hydrogel, based on a functional protein, may advantageously replace methylcellulose and other synthetic gelling agents. The plant-based hydrogel may replace carboxymethylcellulose (CMC) and other synthetic gelling agents in alternative meat products. The plant-based hydrogel may further be used in other products, such as egg-alternative products, fish-alternative products, meat-alternative products, and dairy replacements. The plant-based hydrogel may advantageously have egg-like properties, as opposed to methylcellulose and other synthetic gelling agents, which tend to be too jelly-like.

As used herein, the term “porous” refers to a material having many small holes (pores) that allow air or liquid to pass through them more readily than non-porous materials, which have a much tighter cell structure preventing ease of flow. Glass, metal, plastic, and varnished wood are examples of non-porous materials, while untreated wood, drapes, carpet, membranes, and cardboard are porous.

As used herein, the term “protein matrix” refers to large assemblies of tightly bound proteins forming an extensive network.

According to some embodiments, the composition comprises active residues which upon rehydration enable crosslinking between the matrix and externally added polypeptides.

According to some embodiments, the hydrogel may be formed during preparation of the composition (freshly prepared). Alternatively, the composition may be dried into a powder and the hydrogel formed when the powder is reconstituted/rehydrated (also referred to herein as “prepared from powder” or “from powder”).

According to some embodiments, the concentration of the plant-derived protein in the hydrogel (after hydration) is less than about 50% w/w, less than about 40% w/w less than about 30% w/w, less than 20% w/w or less than 10% w/w. Each possibility is a separate embodiment. According to some embodiments, the concentration of the plant-derived protein in the hydrogel is about 5-30% w/w or about 10-30% w/w or about 10-50% w/w. According to some embodiments, the hydrogel comprises at least about 50% w/w at least about 60% w/w, at least about 70% w/w, at least about 80% w/w or at least about 90% w/w water.

According to some embodiments, the composition has a water retention capability at least comparable to and even higher than that of cellulose derivatives. The composition may have advantageous hardness, springiness, chewiness and/or cohesiveness characteristics. The composition may have improved hardness, springiness, chewiness and/or cohesiveness, as compared to methylcellulose and/or its derivatives.

According to some embodiments, the composition is in the form of an emulsion, and further comprises at least one oil or fat. Advantageously, the emulsion is essentially devoid of an external stabilizer. As a further advantage crosslinked plant-derived polypeptides can form both oil-in-water and water-in-oil emulsions.

According to some embodiments, the present invention provides a stable plant-based emulsion comprising crosslinked plant-derived polypeptides, at least one enzyme selected from an oxidoreductase and an enzyme capable of forming peptide/iso peptide bonds, and at least one oil or fat, wherein the emulsion is essentially devoid of an external stabilizer.

In some embodiments, the oil or fat is edible oil or edible fat. In some embodiments, the oil or fat is oil. In some embodiments, the oil or fat is fat. In some embodiments, the emulsion is an oil-in-water emulsion. In some embodiments, the emulsion is a water-in-oil emulsion.

The edible oil or fat may be any edible oil or fat. In some embodiments, the edible oil or fat is selected from canola oil, olive oil, soy oil, sunflower oil, mustard powder oil, coconut oil, coconut fat, butter, and margarine.

According to some embodiments, the edible oil or fat is not from an animal source. According to some embodiments, the plant protein extract comprises a non-diary oil or fat. According to some embodiments, the edible oil or fat is a plant oil or fat.

In some embodiments, the ratio of the at least one oil or fat and the dry protein is about 100:1, about 50:1, about 25:1, 10:1, about 9:1, about 8:1, about 7:1, about 6:1, about 5:1, about 4:1, about 3:1, about 2:1, about 1.5:1, about 1:1, about 1:1.5, about 1:2, about 1:3, about 1:4, about 1:5, about 1:6, about 1:7, about 1:8, about 1:9, about 1:10, about 1:25, about 1:50 or about 1:100 w/w. Each possibility is a separate embodiment.

According to some embodiments, the emulsion is stable (no phase separation) for at least at least 15 min, at least 20 min, at least 30 min, at least 1 h, at least 2 h, at least 5 h, at least 20 h at least 48 h, at least 72 h at least 96 h, at least a week, at least 2 weeks, at least 1 month or at least 6 months. Each possibility is a separate embodiment.

According to some embodiments, the composition is in the form of a foam, and is essentially devoid of an external non-clean label stabilizer and/or thickener.

According to some embodiments, the present invention provides a stable plant-based foam comprising crosslinked plant-derived polypeptides, at least one enzyme selected from an oxidoreductase and an enzyme capable of forming peptide bonds, wherein the foam is essentially devoid of an external non-clean label stabilizer, thickener or other additive. According to some embodiments, the enzymatic reaction for making the foam includes only one or more hydrolases (and not crosslinking enzymes such as transferases and oxidoreductases).

According to some embodiments, the foam is a vegan whipped cream. According to some embodiments, the foam is a vegan meringue. According to some embodiments, the foam is suitable for baking. According to some embodiments, the foam is a vegan marshmallow. According to some embodiments, the foam is a vegan whipped sesame snack.

According to some embodiments, the foam is dense or firm. According to some embodiments, the foam has a density of 0.1-0.5 g/cm³. According to some embodiments, the foam has a density of 0.2-0.4 g/cm³. According to some embodiments, the foam has a density of 0.3-0.7 g/cm³. According to some embodiments, the foam has a density of above 0.2 g/cm³.

According to some embodiments, the foam is stable (the duration the foam holds its shape without collapsing) for at least at least 5 min, at least 10 min, at least 20 min, at least 30 min, at least 1 h, at least 5 h, at least 12 h at least 24 h, at least 36 h or at least 48 h. Each possibility is a separate embodiment.

According to some embodiments, the foam is suitable for use in baking and cooking (e.g. for forming marshmallows, baked meringue and the like) According to some embodiments, the foam, upon baking or the like may be stable for at least 3 days, at least 5 days, at least 10 days, at least a month, at least 6 months or at least a year. Each possibility is a separate embodiment.

According to some embodiments, the food product is a plant-based meat alternative product, plant-based fish alternative product, egg-less egg alternative product, a dairy replacement product, a chocolate alternative product, an egg-less bakery product, a hybrid meat-plant-based meat alternative product, a hybrid fish-plant-based fish alternative product, a hybrid dairy-plant-based dairy alternative product, a hybrid egg-plant-based egg alternative product, or a combination thereof. Each possibility is a separate embodiment.

According to some embodiments, the change in the cohesiveness of the food product before and after cooking is about 20% less, about 15%, less, about 10% or less or about 5% less than the change in the cohesiveness of a respective food product including methyl cellulose as a gelling agent. Each possibility is a separate embodiment.

According to some embodiments, the change in the hardness of the food product before and after cooking may be about 20% lesser, about 15%, less, about 10% less or about 5% less than the change in the hardness of a respective food product including methyl cellulose as a gelling agent. Each possibility is a separate embodiment.

According to some embodiments, the change in the springiness of the food product before and after cooking is about 20% less, about 15% less, about 10% less or about 5% less than for the change in the springiness of a respective food product including methyl cellulose as a gelling agent. Each possibility is a separate embodiment.

According to some embodiments, the change in the chewiness of the food product before and after cooking is about 20% less, about 15% less, about 10% less or about 5% less than the change in the chewiness of a respective food product including methyl cellulose as a gelling agent. Each possibility is a separate embodiment.

According to some embodiments, the springiness of the hydrogel changes by less than 20%, less than 15%, less than 10% or less than 5% when cooled/heated. Each possibility is a separate embodiment. According to some embodiments, the hardness of the hydrogel changes by less than 20%, less than 15%, less than 10% or less than 5% when cooled/heated. Each possibility is a separate embodiment. According to some embodiments, the gumminess of the hydrogel changes by less than 20%, less than 15%, less than 10% or less than 5% when cooled/heated. Each possibility is a separate embodiment. According to some embodiments, the cohesiveness of the hydrogel changes by less than 20%, less than 15%, less than 10% or less than 5% when cooled/heated. Each possibility is a separate embodiment.

According to some embodiments, the disclosed compositions, gels, emulsions, foams, and protein matrices are combined with other edible ingredients to form a food product, e.g., an artificial meat product which mimics one or more physical characteristics and/or functional properties of meat, such as texture, flavor, aroma, and/or appearance. Optionally, such other ingredients may be selected from apple cider, apple cider vinegar, baking powder, baking soda, beans, beef, beet juice, beet powder, black pepper, brown sugar, butter, canola oil, caramel, carrot fiber, carrots, cashews, cheese, chicken, chocolate, citrus, citrus extract, coconut oil, condensed milk, dairy, egg, egg substitute, fish, flour, garbanzo bean, garlic powder, honey, liquid smoke, maple syrup, margarine, monosodium glutamate, mustard powder, oil, olive oil, onion powder, paprika, pork, potato, potato starch, rice flour, salt, sodium benzoate, soy (protein and/or oil), soy sauce, spices, spirulina, sugar, sunflower oil, tomato juice, tomato powder, tomato sauce, tomatoes, turmeric, vanilla, vinegar, vitamins and minerals, walnuts, water, wheat, wheat flour, wheat gluten, xanthan gum, yeast, yeast extract, etc. and/or combinations thereof.

In some embodiments, the present invention provides a kit comprising a first container/bag comprising preprocessed plant proteins and a second (or more) container(s)/bag(s) comprising one or more enzymes selected from an oxidoreductase, an enzyme capable of forming peptide bonds between amino residues, hydrolase or any combination thereof. According to some embodiments, the preprocessed protein is characterized by unfolding of polypeptide chains and/or exposure of internal sulfhydryl groups, hydrophobic side chains, and/or any other previously buried active sites in the core of the native-state structure. In some embodiments, the preprocessing comprises heating, pressure, extrusion, cold plasma, ultrasound, ultraviolet, or any combination thereof. In some embodiments, the preprocessing comprises homogenization by any suitable method. According to some embodiments, the kit comprises at least two different enzymes, i.e. a hydrolase and a peptide bond forming enzyme or a hydrolase and an oxidoreductase. According to some embodiments, the enzymes may be reversibly inactivated. According to some embodiments, the kit further comprises instructions for use. According to some embodiments, the instruction for use may include instructions regarding which enzyme(s) to use, the concentration of the enzyme(s) and/or the duration of the enzymatic process that is suitable for forming a hydrogel, a foam and/or an emulsion, respectively. According to some embodiments, the kit may further include one/or more containers/bags with additional ingredients. According to some embodiments, the instructions may further include instructions regarding the addition of the one or more additional ingredients.

In some embodiments, the present invention provides a method for producing a crosslinked plant-protein product, the process comprising:
a. mixing plant-derived polypeptides with at least one enzyme selected from an oxidoreductase, an enzyme capable of forming peptide bonds between amino residues, hydrolase or any combination thereof;
b. incubating at conditions allowing crosslinking of at least a portion of the plant-derived polypeptides.

In some embodiments, the crosslinked plant-protein is a porous plant protein matrix capable of forming a hydrogel when hydrated.

In some embodiments, the method further comprises hydrating the plant-derived polypeptides by mixing with water before step (a).

In some embodiments, the method further comprises preprocessing or pretreating the plant- derived polypeptides at least before step (a). In some embodiments, the preprocessing or pretreating of the plant-derived polypeptides continues during the mixing in step (a).

In some embodiments, the preprocessing comprises heating, pressure, pre, extrusion, cold plasma, ultrasound, ultraviolet, or any combination thereof. In some embodiments, the preprocessing comprises homogenization by any suitable method.

In some embodiments, the method further comprises adding at least one hydrolase at step (a), before adding the at least one enzyme selected from an oxidoreductase and/or a transferase.

In some embodiments, the method further comprises adding at least one hydrolase at step (a), after adding the at least one enzyme selected from an oxidoreductase and/or a transferase.

In some embodiments, the method further comprises adding at least one hydrolase at step (a), together with the at least one enzyme selected from an enzyme oxidoreductase and/or a transferase.

In some embodiments, in particular for foams and emulsion, only a hydrolase or only isomerase or both may be added in step (a), without adding oxidoreductase and/or a transferase.

In some embodiments, the at least one enzyme is an enzyme mixture. In some embodiments, the enzyme mixture is reversibly or temporarily inactivated.

In some embodiments, the hydrolase is an enzyme capable of degrading polysaccharides or a lipase. In some embodiments, the hydrolase is an enzyme capable of degrading polysaccharides. In some embodiments, the hydrolase is a lipase.

In some embodiments, the mixing in step (a) further comprises adding one or more cofactors, salts, vitamins and/or minerals.

In some embodiments, the method further comprises drying the crosslinked plant-protein product into a powder.

In some embodiments, the drying comprises freeze drying, spray drying, or vacuum drying.

In some embodiments, the crosslinked plant-protein product is an emulsion, and the method further comprises further adding in step (a) at least one oil or fat.

In some embodiments, the at least one oil or fat is gradually mixed with the plant-derived polypeptides or with the plant-derived polypeptides and at least one enzyme.

According to some embodiments, the polypeptide and/or protein undergoes preprocessing. According to some embodiments, the preprocessing includes thermal treatment of a polypeptide and/or protein solution, pressure, homogenization or the like. According to some embodiments, and without being bound by any theory, as a consequence of the preprocessing, the polypeptide chains unfold and internal sulfhydryl groups, hydrophobic side chains, and/or any other previously buried active sites in the core of the native-state structure, become more exposed. According to some embodiments, enzymatic crosslinking provides bonds, optionally covalent bonds, between protein and/or polypeptide chains under mild conditions, and/or result in reactive compounds that may optionally polymerizes and/or lead to covalent crosslinking spontaneously. Enzymatic crosslinking may allow for stable protein-protein binding and protein-pectin binding without external stabilizers.

According to some embodiments, the composition is dehydrated to form a solid, or a powder. According to some embodiments, dehydration is conducted by freeze drying, spray drying, vacuum drying, centrifuging, pressing, lyophilizing, hot air drying, drying under hot inert gases, screen mash, and/or any methods suitable to remove water or fluids. According to some embodiments, the powder has a particle size distribution of between about 5 μm to about 5 mm, between about 50 μm to about 1 mm, or between about 0.1 to about 0.5 mm. Each possibility is a separate embodiment.

In some embodiments, the present invention provides a method for the preparation of a plant-based emulsion, comprising:
a. mixing plant-derived polypeptides, at least one enzyme selected from oxidoreductase, an enzyme capable of forming peptide/iso peptide bonds between amino residues, a hydrolase and any combination thereof with at least one oil or fat; and
b. incubating at conditions allowing crosslinking of at least a portion of the plant-derived polypeptides.

According to some embodiments, the method may additionally or alternatively comprise a step of homogenization.

The stability of the plant-based emulsion of the invention is due, inter alia to enzymatic processes, which result in exposing functional amino acid residues. It is assumed that the exposed residues stabilize the emulsion by the exposed hydrophobic residues presumably facing the oil phase, while the hydrophilic residues presumably facing the aqueous phase.

Accordingly, in some embodiments, the present invention provides a method for the preparation of a plant-based foam, comprising:
a. mixing plant-derived polypeptides with at least one enzyme selected from an oxidoreductase, an enzyme capable of forming peptide/iso-peptide bonds between amino residues, a hydrolase or any combination thereof;
b. incubating at conditions allowing crosslinking of at least a portion of the plant-derived polypeptides; and
c. rigorously whipping at a high-shear speed until a stable foam is formed.

According to some embodiments, the method may additionally or alternatively comprise a step of homogenization.

It is understood to one of ordinary skill in the art that at least some of the steps may be performed in an alternative order and/or be performed simultaneously.

The stability of the plant-based foam of the invention is due, inter alia to enzymatic processes such as: adding hydrolyses such as lipases to degrade fats in the plant-derived polypeptides that can interfere to the foam creation; adding hydrolyses such as carbohydrates degrading enzymes (glycosidases) that create mediators from materials in the plant-derived polypeptides that can stabilize foam; and/or adding oxidoreductases (glucose oxidase) that can create peroxide in the presence of glucose present in the plant-derived polypeptides, which can also stabilize foam.

According to some embodiments, the incubation conditions for crosslinking include maintaining the temperature below about 90° C., below about 80° C., below about 70° C., below about 60° C., below about 50° C., below about 45° C., below about 40° C., below about 35° C., below about 30° C., below about 25° C., below about 20° C., below about 15° C., below about 10° C., below about 5° C. for an extended period of time. According to some embodiments, the extended period of time is at least about 30 mins, at least about 1 hr, at least about 2 hrs, at least about 3 hrs, at least about 4 hrs, at least about 5 hrs, at least about 6 hrs, at least about 7 hrs, at least about 8 hrs, at least about 9 hrs, at least about 10 hrs, at least about 11 hrs, at least about 12 hrs, at least about 13 hrs, at least about 14 hrs, at least about 15 hrs, at least about 20 hrs, or at least about 24 hrs.

According to some embodiments, the process further includes a step of preprocessing the plant-based polypeptides prior to and/or during the mixing with the at least one enzyme, in order to expose amino acid residues. According to some embodiments, the preprocessing includes a physical treatment such as heating, pressure, sonication or any combination thereof. According to some embodiments, the preprocessing includes a physical treatment such as heating, pressure, sonication, extrusion, cold plasma, ultrasound, ultraviolet or any combination thereof. According to some embodiments, ultrasound treatment includes sonication. According to some embodiments, heating includes conventional heating, ohmic heating, microwave heating, radiofrequency heating, and/or infrared heating. According to some embodiments, heating is at a high temperature for short time, and/or mild temperature for a long time period, e.g., about 80-90° C. for 3-30 min, about 40 to about 60° C. for about 3 or less to about 9 hours, about 80-95° C. for 1 hour, etc. According to some embodiments, the heating is carried with mixing. According to some embodiments, the heating is carried without mixing. According to some embodiments, high pressure treatment is static. According to some embodiments, high pressure treatment is dynamic. According to some embodiments, extrusion includes thermo-mechanical processes, which combine high heat, high shear, and/or high pressure to cause cooking, sterilization, drying, melting, conveying, kneading, puffing texturizing, and/or forming of a food product. According to some embodiments, cold plasma treatment is used, creating a state of matter that contains a cocktail of reactive oxygen species, reactive nitrogen species (O·, ·OH, N·, HO²·, N₂*, N*, OH⁻, O²⁻, O⁻, O²⁺, N²⁺, N⁺, NO, O⁺, O₃, and/or H₂O₂) and ultraviolet radiations generated when the energy supplied to a gaseous environment dissociates the gas molecular bonds into fully or partially ionized gases (plasma). The energy discharge source may be electrical, thermal, optical, electromagnetic, etc. Each possibility is a separate embodiment.

According to some embodiments, the process includes adding to the plant-derived polypeptides at least one hydrolase enzyme. According to some embodiments, the at least one hydrolase enzyme is capable of degrading polysaccharides or fats.

According to some embodiments, the process includes adding to the plant-derived polypeptides at least one enzyme capable of degrading polysaccharides prior to the mixing with one or more oxidoreductase and/or the at least one enzyme capable of forming peptide/iso-peptide bonds.

According to some embodiments, the at least one hydrolase, such as an enzyme capable of degrading polysaccharides or a lipase, is added to the plant-derived proteins or polypeptides after the preprocessing.

According to some embodiments, the at least one hydrolase enzyme, such as an enzyme capable of degrading polysaccharides or a lipase, is added to the plant-derived proteins or polypeptides together with the one or more oxidoreductase and/or one or more enzyme capable of forming peptide/iso-peptide bonds.

According to some embodiments, the at least one hydrolase, such as an enzyme capable of degrading polysaccharides or a lipase, is added to the plant-derived proteins or polypeptides before the addition of the one or more oxidoreductase and/or one or more enzyme capable of forming peptide bonds.

According to some embodiments, the at least one hydrolase, such as an enzyme capable of degrading polysaccharides or a lipase, is added to the plant-derived proteins or polypeptides after the addition of the one or more oxidoreductase and/or one or more enzyme capable of forming peptide bonds.

According to some embodiments, all enzymes are added to the plant-derived proteins or polypeptides at the same time.

According to some embodiments, any of the enzymes are added to the plant-derived proteins or polypeptides separately from other enzymes.

According to some embodiments, the enzymes are added to the plant-derived proteins or polypeptides sequentially at any order.

According to some embodiments, the process further includes a step of generating a reversibly or temporarily inactivated enzyme mixture. According to some embodiments, the mixture includes one or more oxidoreductase (or an oxidoreductase) and/or one or more enzyme capable of forming peptide/iso-peptide bonds (a crosslinking enzyme) and one or more enzymes capable of degrading polysaccharides (a hydrolase such as a glycosidase).

According to some embodiments, the process includes a step of irreversibly inactivating the enzyme mixture, such that the enzymes in the final powder, hydrogel, foam, emulsion are irreversibly inactivated.

According to some embodiments, the mixing includes adding one or more cofactors, vitamins and/or minerals.

According to some embodiments, the process includes drying the composition to a powder capable of forming a hydrogel when hydrated. According to some embodiments, the drying includes freeze drying, spray drying, vacuum drying, centrifuging, pressing, lyophilizing, hot air drying, drying under hot inert gases, screen mash, and/or any methods suitable to remove water or fluids and combination thereof.

A texture profile analysis (TPA) test is a 2-cycle (two bite) compression test with a time delay between the cycles. The sample is usually bite sized (e.g., 1 cm³) and the deformation is typically between about 75% to about 90% of the height to simulate chewing by teeth. The test was originally developed by Friedman and Szczesniak at the General Foods Corporation, and was later modified by Malcolm Bourne wherein some parameters were slightly amended.

A TPA test may be used to calculate or determine to test a variety of parameters characteristic of the sample, e.g., hardness, cohesiveness, springiness, gumminess, chewiness, resilience, stickiness, adhesiveness, stringiness, etc.

Resilience is a measurement of how the sample recovers from deformation and is not a parameter from the original Texture Profile Analysis concept.

It is the ratio of the work (area under the curve) given back by the sample during the first release divided by the work absorbed by the sample during the first compression, i.e. Area 4/Area 3.

Stickiness is the minimum peak force during the first compression cycle (first bite)—Refers to the Soft “Sticky” Material” graph, i.e., Peak force in negative region.

Adhesiveness is the negative work (area under the curve) for the first bite so is the work required to overcome the attractive forces between the food and the compression plates-Refer to the Soft “Sticky” Material” graph, i.e. Work done in negative region =A3 in the second graph type.

Stringiness is the distance the product is extended during decompression before separating from the compression probe and is not a parameter from the original Texture Profile Analysis concept.

Additionally, the parameters may be physical and/or sensory (e.g., while chewing), for examples see Table 1 below.

TABLE 1

| | Physical | Sensory |
|---|---|---|
| Hardness | Force necessary to attain a given | Force required to compress a substance |
| | deformation | between molar teeth (in the case of |
| | | solids) or between tongue and palate (in |
| | | the case of semi-solids). |
| Cohesiveness | Extent to which a material can be | Degree to which a substance is |
| | deformed before it ruptures. | compressed between the teeth before it |
| | | breaks. |
| Springiness | Rate at which a deformed | Degree to which a product returns to its |
| | material goes back to its | original shape once it has been |
| | undeformed condition after the | compressed between the teeth |
| | deforming force is removed | |
| Chewiness | Energy required to masticate a | Length of time (in sec) required to |
| | solid food to a state ready for | masticate the sample, at a constant rate of |
| | swallowing: | force application, to reduce it to a |
| | a product of | consistency suitable for swallowing, or |
| | hardness, cohesiveness and | by the number of chews that are required |
| | springiness | to make it suitable for swallowing |

According to some embodiments, the cohesiveness of the food product changes by less than about 5%, less than about 10%, or less than about 15% before and after cooking.

According to some embodiments, the hardness of the food product changes by less than about 5%, less than about 10%, or less than about 15% before and after cooking.

According to some embodiments, the springiness of the food product changes by less than about 5%, less than about 10%, or less than about 15% before and after cooking.

According to some embodiments, the chewiness of the food product changes by less than about 5%, less than about 10%, or less than about 15% before and after cooking.

Reference is now made to the figures.

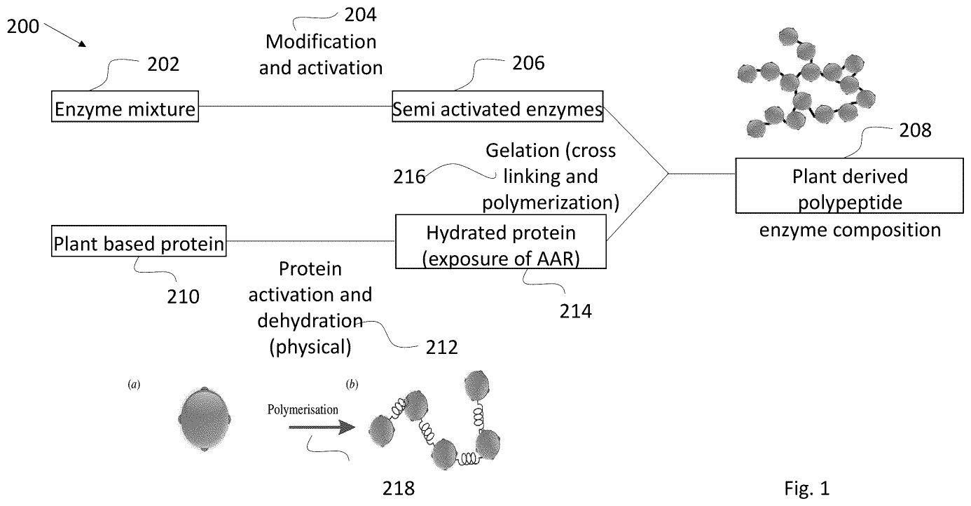

FIG. 1 is a schematic diagram of a process for production of composition in accordance with some embodiments. For example, in the process 200, an enzyme mixture 202 may undergo combination, modification, treatment and/or activation 204 to produce a reversibly or temporarily inactivated enzyme mixture 206. According to some embodiments, the modification and activation may include an enzymatic treatment (e.g. with a crosslinking enzyme and a hydrolase) in combination with a physical treatment, such as heating, pressure treatment, sonication or the like and combinations thereof. According to some embodiments, the modification and activation may include an enzymatic treatment (e.g. with a crosslinking enzyme and a hydrolase) only. According to some embodiments, the modification and activation may include an enzymatic treatment with a hydrolase.

Plant-based proteins 210 may be activated and/or dehydrated 212 e.g., to produce powdered protein and/or texturized vegetable protein, which may then be hydrated to expose the amino acid residues (AAR) 214. The enzymes 206 may then be added to the protein 212. Gelation (crosslinking and polymerization) 216 of the hydrated plant-based protein 214 with the semi-activated enzymes 206 produces the protein-enzyme matrix, which may be hydrated to form a hydrogel 208. Polymerization of amino acids (a) or peptides to produce polypeptides (b) 218 may produce synthetic plant-based polypeptides.

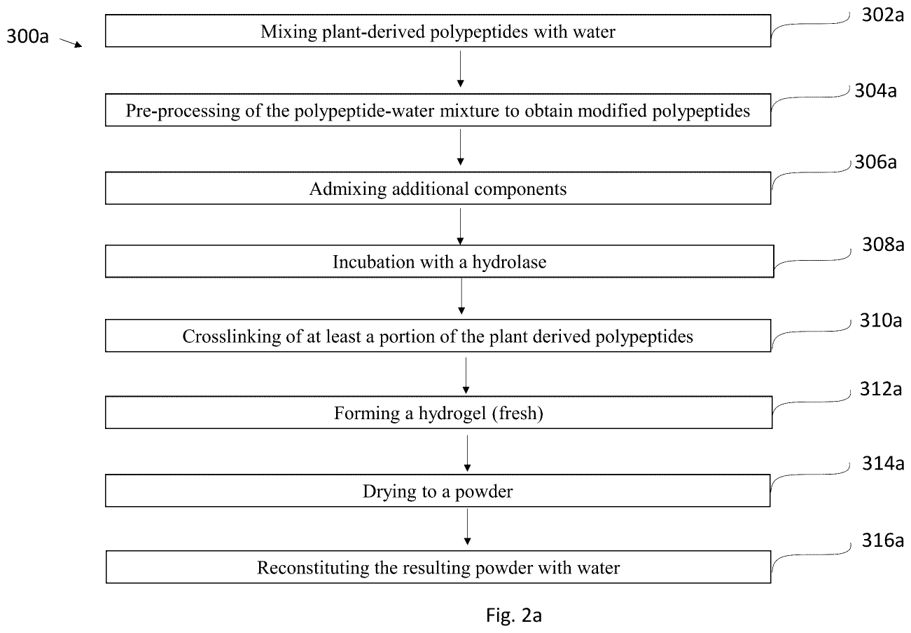

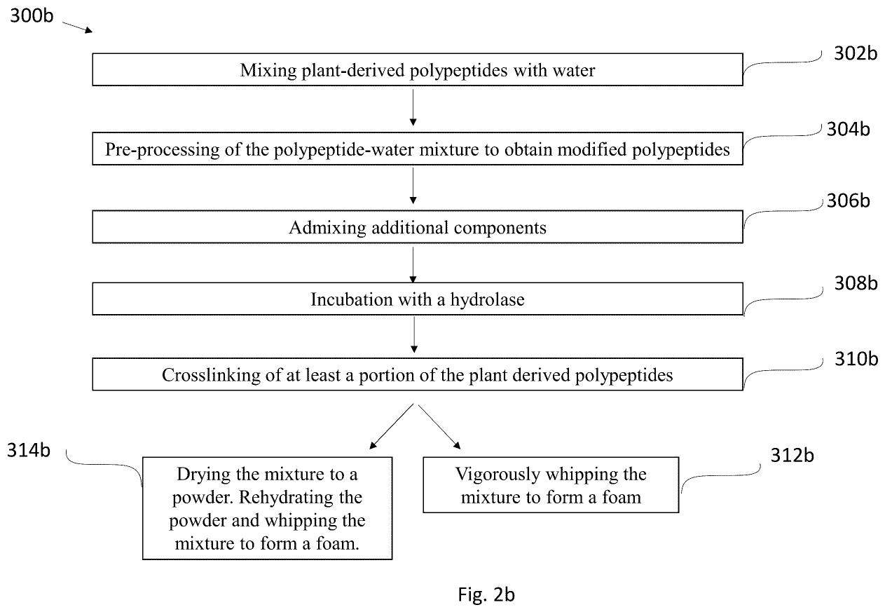

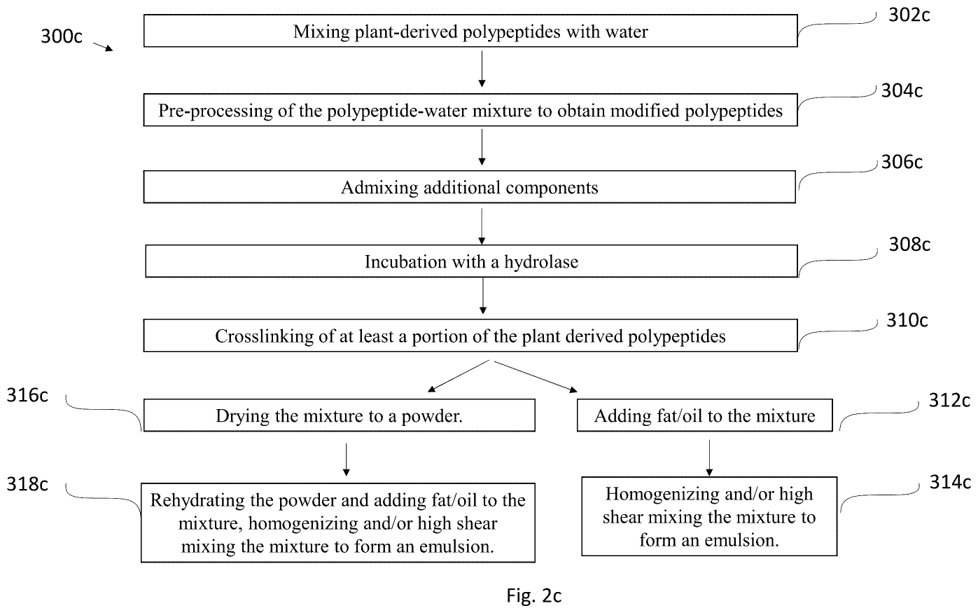

FIG. 2a is an exemplary flow diagram 300a of a process for production of a hydrogel composition in accordance with some embodiments. For example, in step 302a plant-based polypeptides may be mixed with water. In step 304a, the polypeptide-water mixture is optionally heated or otherwise preprocessed to cause exposure of buried residues in the polypeptide, followed by cooling to a temperature optimal for the enzymatic reaction. As a further option, in step 306a additional components such as cofactors, salts, nutrients, minerals, fibers, etc., may be admixed. In step 308a at least a portion of the plant-derived polypeptides is incubated with a hydrolase (preferably a glucosidase), and in step 310a the polypeptide are at least partially crosslinked to form the protein-enzyme matrix by incubating the polypeptide with an oxidoreductase and/or at least one transferase at a temperature suitable for the reaction, thereby forming a hydrogel (Step 312a). It is understood that steps 308a and 310a may be performed together in a single reaction step or sequentially. The hydrogel may optionally be dried 314a to form a powder, which can be reconstituted into a hydrogel when hydrated (step 316b).

FIG. 2b is an exemplary flow diagram 300b of a process for production of a foam in accordance with some embodiments. For example, in step 302b plant-based polypeptides with water. In step 304b, the polypeptide-water-mixture is optionally heated or otherwise preprocessed to cause exposure of buried residues in the polypeptide, prior to the enzymatic reaction. As a further option, in step 306b additional components such as cofactors, salts, sugar, nutrients, minerals, fibers, etc., may be admixed. In step 308b at least a portion of the plant-derived polypeptides is incubated with a hydrolase (preferably a glucosidase) and/or optionally an isomerase. According to some embodiments, only a hydrolase is used in the enzymatic reaction. Alternatively, in step 310b the polypeptides are further at least partially crosslinked to form the protein-enzyme matrix, by incubating the polypeptide with at least one oxidoreductase and/or at least one transferase. It is understood that step 308b and 310b may be performed concurrently with or after the addition of the hydrolase. In step 312b the mixture may be whipped vigorously to form a foam (Step 310b). Alternatively, the process may include a step 314b of drying the mixture into a powder, rehydrating the powder, and whipping the mixture to form a foam.

FIG. 2c is an exemplary flow diagram 300c of a process for production of a foam in accordance with some embodiments. For example, in step 302c plant-based polypeptides with water. In step 304c, the polypeptide-water-mixture is optionally heated or otherwise preprocessed to cause exposure of buried residues in the polypeptide, prior to the enzymatic reaction. As a further option, in step 306c additional components such as cofactors, salts, sugar, nutrients, minerals, fibers, etc., may be admixed. In step 308c at least a portion of the plant-derived polypeptides is incubated with a hydrolase (preferably a glucosidase) and/or optionally an isomerase. According to some embodiments, only a hydrolase is used in the enzymatic reaction. Alternatively, in step 310b the polypeptides are further at least partially crosslinked to form the protein-enzyme matrix, by incubating the polypeptide with at least one enzyme oxidoreductase and/or at least one transferase. It is understood that step 308c and 310c may be performed concurrently with or after the addition of the hydrolase. In step 312c an oil and/or fat is added, and the mixture homogenized and/or high shear mixed to form an emulsion (Step 314c). Alternatively, the process may include a step 316c of drying the mixture into a powder, rehydrating the powder, followed by step 318c of adding a fat and/or oil and homogenizing/high shear mixing the mixture to form an emulsion.

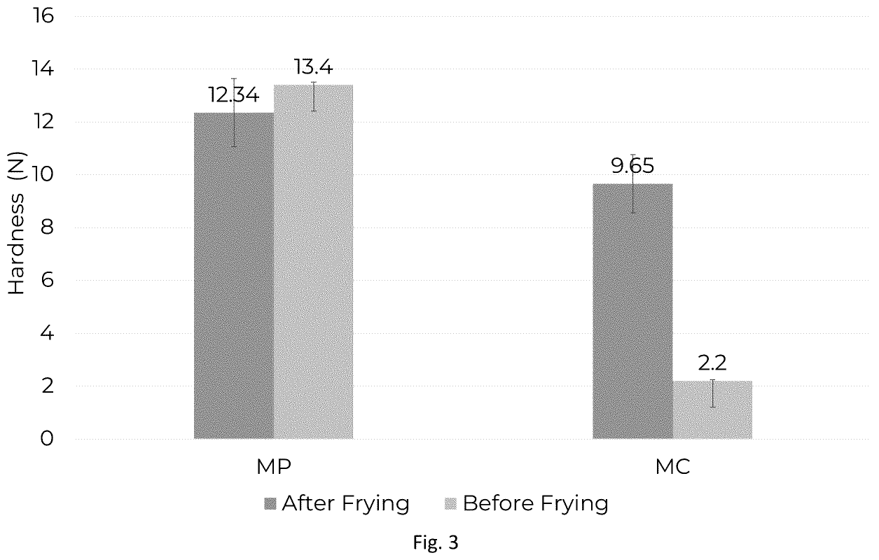

FIG. 3 is a graph comparing the gel results analysis for hardness (N), defined as the highest peak force measured during first compression, in accordance with some embodiments. Hardness is the physical force necessary to attain a given deformation.

In sensory terms, this is the force required to compress a substance between molar teeth (in the case of solids) or between tongue and palate (in the case of semi-solids). In a TPA test, this is the maximum peak force during the first compression cycle (first bite) and has often referred to as firmness. Additionally, fracturability (originally called brittleness) is the force at the first significant break in the TPA curve (if present).

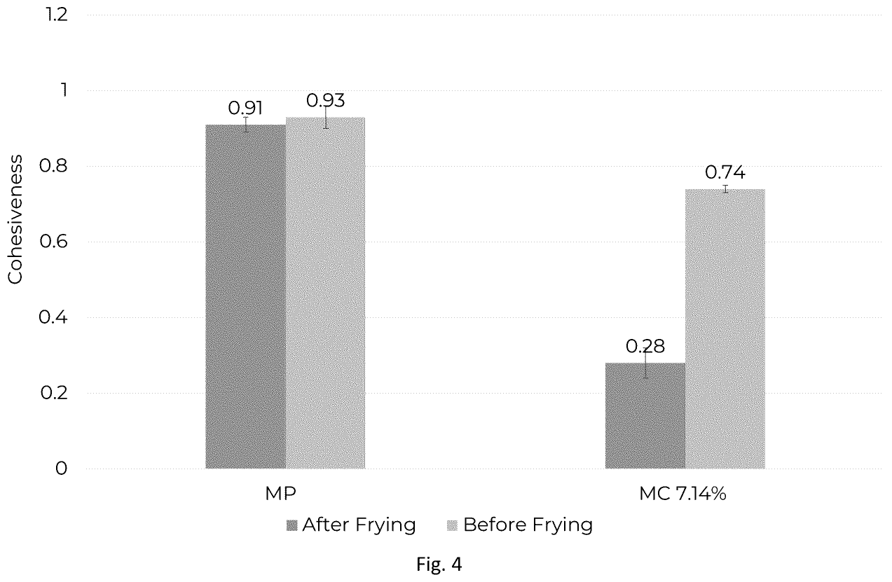

FIG. 4 is a graph comparing the gel results analysis for cohesiveness in accordance with some embodiments. Cohesiveness is defined as the extent to which a material can be deformed before it ruptures. In sensory terms, it is the degree to which a substance is compressed between the teeth before it breaks. In a TPA curve, this is the ratio of the work (area under the curve) during second compression divided by the work during first compression, i.e.—Area 2/Area 1.

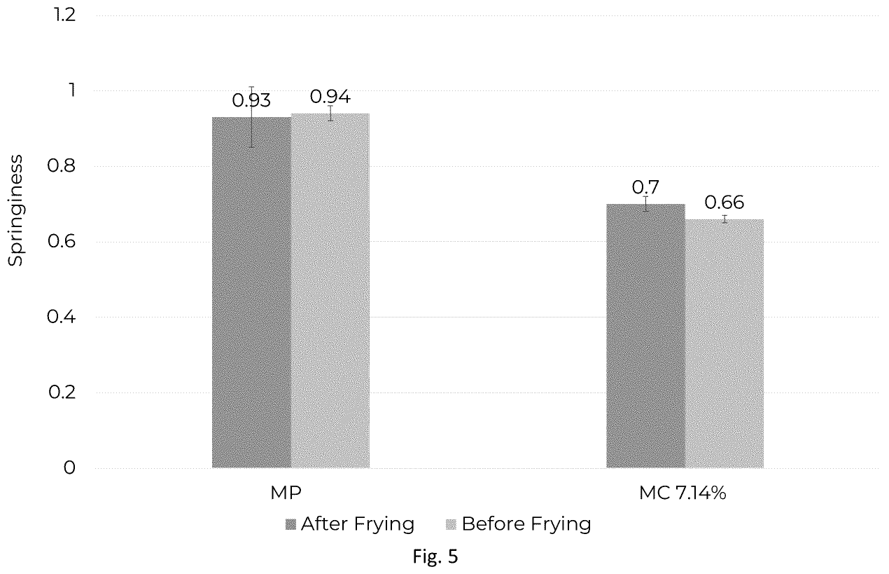

FIG. 5 is a graph comparing the gel results analysis for springiness in accordance with some embodiments. Springiness is the rate at which a deformed material returns to its undeformed condition after the deforming force is removed. In sensory terms, this is the degree to which a product returns to its original shape once it has been compressed between the teeth. In a TPA curve, this is the permanent compression of the sample after the first cycle, i.e., difference—Distance 2/Distance 1.

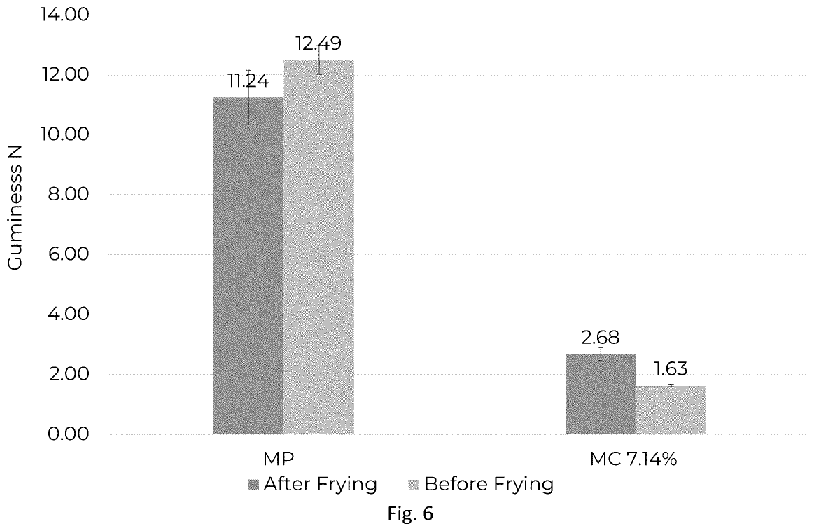

FIG. 6 is a graph comparing the gel results analysis for gumminess in accordance with some embodiments. In a TPA curve, gumminess is reported for semisolids and is the product of Hardness*Cohesiveness, i.e.—Hardness*(Area2/Area 1)=Hardness*Cohesiveness.

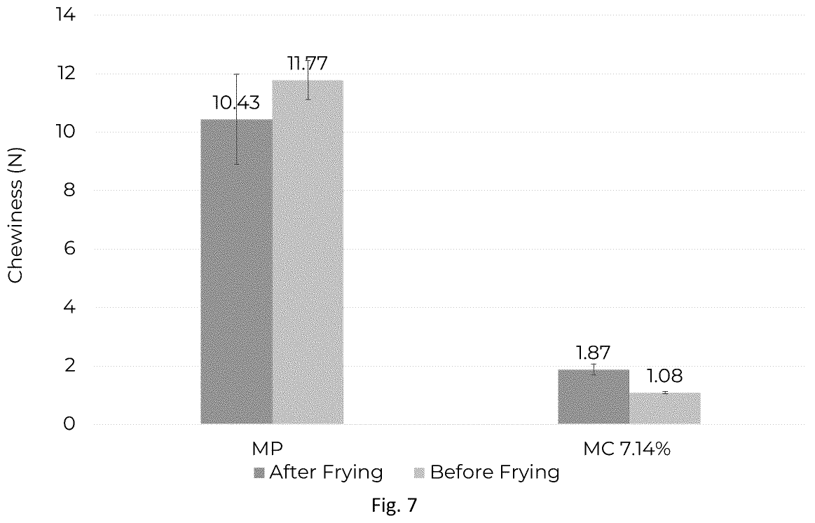

FIG. 7 is a graph comparing the gel results analysis for chewiness in accordance with some embodiments. Chewiness is defined as the force required to masticate a solid food to a state ready for swallowing: a product of hardness, cohesiveness and springiness. In sensory terms, chewiness is a parameter used for solid foods and is a measure of how much force is required to chew a particular foodstuff before it can be swallowed and is also a useful indicator for mouthfeel. In a TPA curve, this should be reported for solids and is defined as the product of gumminess*springiness (which equals hardness×cohesiveness×springiness): Gumminess*(Distance 2/Distance 1)=Hardness*Cohesiveness*Springiness.

While certain embodiments of the invention have been illustrated and described, it will be clear that the invention is not limited to the embodiments described herein. Numerous modifications, changes, variations, substitutions and equivalents will be apparent to those skilled in the art without departing from the spirit and scope of the present invention as described by the claims, which follow.

The following examples are presented in order to more fully illustrate some embodiments of the invention. They should in no way be construed, however, as limiting the broad scope of the invention. One skilled in the art can readily devise many variations and modifications of the principles disclosed herein without departing from the scope of the invention.

The invention will now be illustrated by the following non-limiting Examples.

### EXAMPLES

### Example 1

### Preparation of Hydrogel and Formulations

Several exemplary hydrogel formulations were prepared using soy protein, chickpea protein, pea protein and canola proteins. Numerous modifications, changes, variations, substitutions and equivalents will be apparent to those skilled in the art without departing from the spirit and scope of the exemplary hydrogel formulations, which follow.

The hydrogel was prepared by mixing protein with water. The protein water mixture was either heated and cooled, or left untreated, before adding the enzyme mixture in a ratio of about 1:0.01-0.05 protein to enzyme ratio, optionally along with a cofactor. If required, water was added during mixing to obtain a hydrogel with a desired consistency.

Additional formulations including other proteins derived from other plants whether in the form of a concentrate or isolated proteins are also prepared. Optionally, the hydrogel may be dehydrated to form a powder. Such powders can be reconstituted into a hydrogel by adding water and optionally mixing it at a high shear speed.

### Example 2

### Water Retention and Cooking Loss

### Methods

Four methods, which are listed below, were tested:
1. Cooking loss—by weighing the samples before baking and after baking. The baking procedure includes heating the samples at 100-110° C. for 15-20 min.

$$\% Cooking loss = ( 1 - \frac{Weight after baking}{Weight before baking} ) * 100$$

2. Cooking loss—by weighing the samples before frying and after frying at equal oil amount.

$$\% Cooking loss = ( 1 - \frac{Weight after frying}{Weight before frying} ) * 100$$

3. Water holding Capacity—By centrifuging the samples coated with bakery paper or filter paper. Two groups of samples were tested, one group was centrifuge after frying while the second group was centrifuge without the frying before.

$$\% water holding capacity = ( \frac{Weight after centrifuge}{Weight before centrifuge} ) * 100$$

4. Cooking yield—by weighing the samples before baking/frying and after baking/frying. The baking procedure includes heating the samples at 100-250° C. for 15-20 min.

$$\% Cooking yield = ( \frac{Weight after baking / frying}{Weight before baking / frying} ) * 100$$

### Results

The results are shown in Table 3 below and demonstrate the excellent water capacity of the hydrogel.

TABLE 3
water retention and cooking loss

| | | Cooking | Water |
|---|---|---|---|
| Sample I.D | Test Method | Loss | capacity |
| Composition 1 | Baking for 18 min at 100° C. | 20.08% | |
| (soy, TG, PME) | | 20.47% | |
| | Baking for 15 min at 105° C. | 19.98% | |
| | Frying | 11.33% | |
| | | 16.94% | |
| | Centrifuge without frying | | 88.21% |
| | before | | |
| | Centrifuge after frying | | 81.65% |
| Composition 2 | Frying | 20% | |
| (soy, laccase, | | 26% | |
| PME) | Centrifuge without frying | | 71.27% |
| | before | | |
| methyl | Baking for 18 min at 100° C. | 19.84% | |
| cellulose | Baking for 15 min at 105° C. | 17.7% | |
| | Centrifuge after frying | | 83.33% |
| | Centrifuge without frying | | 89.10% |
| | before | | |

Similar results were also obtained for matrices including proteins from other sources (chickpea, pea and canola as well as for matrices utilizing amylase instead of pectinmethylesterase (formulations 5-15), data not shown).

The water retention and cooking loss of additional matrices, such as matrices including proteins obtained from other plant protein sources, using other enzymes is also evaluated.

### Example 3

### Texture Analysis

In FIGS. 3-7, a texture profile analysis (TPA) test was undertaken on a sample of the plant-based matrix (MP) (Composition 1) was compared with a sample of a methylcellulose matrix (MC), and a variety of parameters calculated therefrom. The TPA test was a double compression cycle performed at 10 mm/min until a recorded deformation of 50% was achieved, 2-4 repeats of each sample were performed. The sample size was about 33 mm in diameter and 2 cm height.

The following parameters were used: test Mode—TPA; pre-load Speed—20 mm/min; pre-load 0.1 N; test speed—10 mm/min.

FIG. 3 is a graph comparing the gel results analysis for hardness (N), defined as the highest peak force measured during first compression, in accordance with some embodiments. Hardness is the physical force necessary to attain a given deformation.

As seen from FIG. 3, the herein disclosed plant-based gel (MP) advantageously has similar hardness before and after frying, whereas the methylcellulose gel (MC) shows greatly increased hardness after frying. This is an indication of the thermos-resistance of the herein disclosed hydrogels and is advantageous because a change in hardness as the food product cools down is unpleasant in the mouth and may change the appearance and consistency of the food product.

FIG. 4 is a graph comparing the gel results analysis for cohesiveness in accordance with some embodiments. Cohesiveness is defined as the extent to which a material can be deformed before it ruptures.

The herein disclosed plant-based gel (MP) advantageously has similar cohesiveness before and after frying, whereas the methylcellulose gel (MC) shows greatly reduced cohesiveness after frying. A stable cohesiveness is essential because it is important that the food product not lose its consistency (e.g., fall apart) on cooking.

FIG. 5 is a graph comparing the gel results analysis for springiness in accordance with some embodiments. Springiness is the rate at which a deformed material returns to its undeformed condition after the deforming force is removed.

Both the herein disclosed plant-based gel (MP) and the methylcellulose gel (MC) show similar springiness before and after frying, however, advantageously the springiness of the MP is greater than that of the MC both before and after frying. Improved springiness is important as it is similar to the springiness found in animal proteins.

FIG. 6 is a graph comparing the gel results analysis for gumminess in accordance with some embodiments.

Both the herein disclosed plant-based gel (MP) and the methylcellulose gel (MC) show similar gumminess before and after frying, however, advantageously the gumminess of the MP is far greater than that of the MC both before and after frying. Improved gumminess is important as it is similar to the springiness found in animal proteins.

FIG. 7 is a graph comparing the gel results analysis for chewiness in accordance with some embodiments. Chewiness is defined as the energy required to masticate a solid food to a state ready for swallowing: a product of hardness, cohesiveness and springiness.

The chewiness of the herein disclosed plant-based gel (MP) is significantly higher than the chewiness of the methylcellulose gel (MC). This implies that the MP hydrogel advantageously feels less ‘squidgy’ during mastication, and has more structure compared to the MC gel.

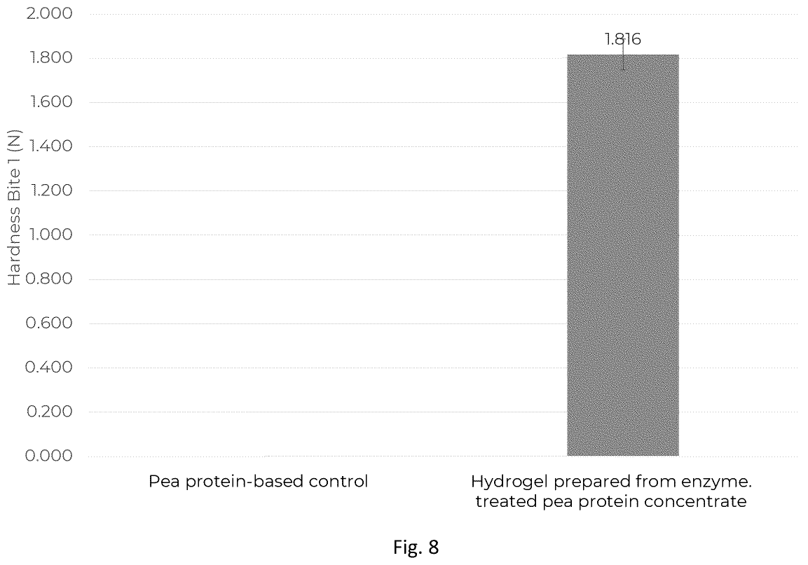

FIG. 8, shows a TPA hardness (N) test results obtained for a sample of the herein disclosed pea-protein based hydrogel (here freshly prepared) and for the pea-based control (raw material, without enzymatic treatment). The TPA test was a double compression cycle performed at 10 mm/min until a recorded deformation of 30% was achieved, 3 repeats of each sample were performed, taken from different areas in the plate.

As seen from FIG. 8, the herein disclosed pea-based gel (freshly prepared) has a force value of 1.8N while the pea-based control (raw material, without enzymatic treatment), was unable to form a hydrogel at all (and was thus assigned the value 0).

### Example 4

### Comparison to Albumen

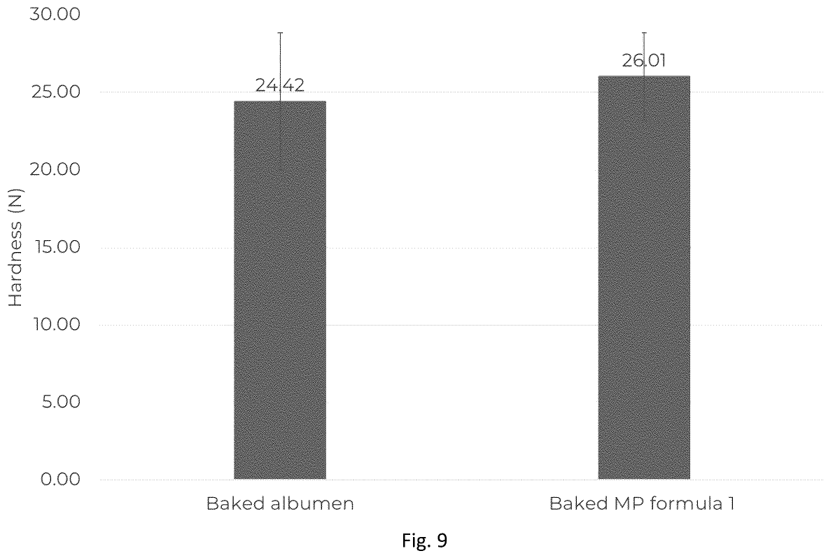

FIGS. 9-12, show TPA test obtained for a sample of the plant-based matrix (MP) (Composition 1) and for the egg white protein albumen. The TPA test was a double compression cycle performed at 10 mm/min until a recorded deformation of 50% was achieved, 2-4 repeats of each sample were performed. The sample size was about 33 mm in diameter and 2 cm height. Similar results were obtained from formulations 2-4 (not shown).

FIG. 9 is a graph comparing the gel results analysis for hardness (N), defined as the highest peak force measured during first compression, in accordance with some embodiments. Hardness is the physical force necessary to attain a given deformation.

As seen from the figure, the herein disclosed plant-based gel (MP) advantageously has similar hardness to that of the egg white protein (albumen) when baked for 40 min at 140° C., emphasizing the ability of the protein to serve as an egg white substitute.

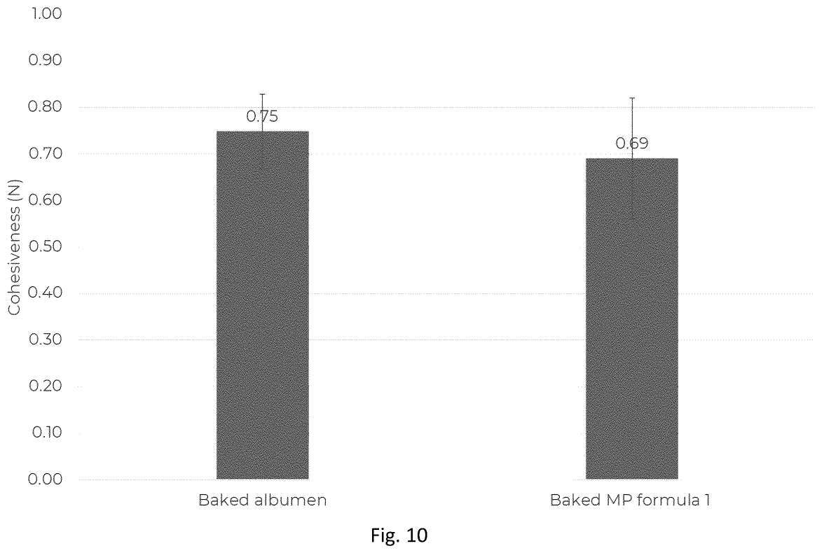

FIG. 10 is a graph comparing the gel results analysis for cohesiveness in accordance with some embodiments. Cohesiveness is defined as the extent to which a material can be deformed before it ruptures.

Again, the herein disclosed plant-based gel (MP) advantageously has similar cohesiveness to that of the egg white protein (albumen) when baked for 40 min at 140° C., emphasizing the ability of the protein to serve as an egg white substitute.

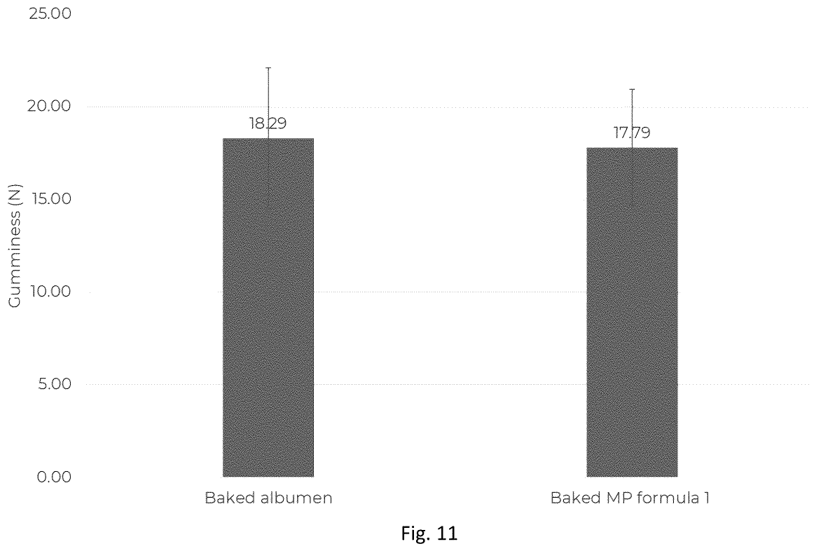

FIG. 11 is a graph comparing the gel results analysis for gumminess in accordance with some embodiments.

Again, as seen from the figure, the herein disclosed plant-based gel (MP) advantageously has similar gumminess to that of the egg white protein (albumen) when baked for 40 min at 140° C., emphasizing the ability of the protein to serve as an egg white substitute.

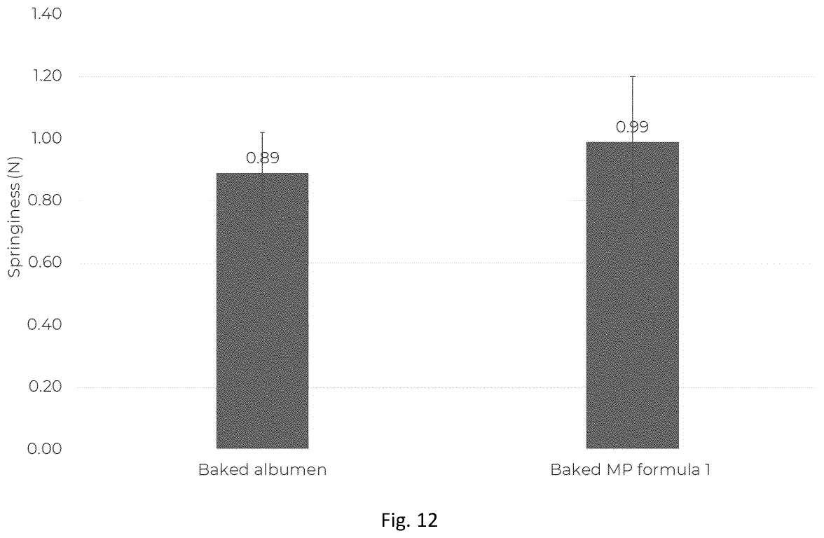

FIG. 12 is a graph comparing the gel results analysis for springiness in accordance with some embodiments. Springiness is the rate at which a deformed material returns to its undeformed condition after the deforming force is removed.

As seen from the graph, the herein disclosed plant-based gel (MP) advantageously has also a similar chewiness to that of the egg white protein (albumen) when baked for 40 min at 140° C., emphasizing the ability of the protein to serve as an egg white substitute.

### Example 5

### Rheological Testing of the Gels

The gels prepared from the above compositions were tested by oscillatory tests in order to characterize their viscoelastic properties. The soy compositions were tested by frequency oscillatory and amplitude oscillatory testing, and the pea-based compositions were tested by frequency oscillatory testing. The compositions tested all include preprocessed polypeptides enzymatically treated with crosslinking enzyme and hydrolase. The tested compositions were compared to control compositions prepared without treatment with the crosslinking enzyme and the hydrolases (i.e., untreated pea protein).

The oscillatory testing was done using a Netzsch Kinexus Pro+Rheometer at 25° C., with the following parameters: 40 mm roughened upper plate; 61 mm roughened lower plate, however other rheometers and parameters may also be used.

G′ represents the storage modulus, which measures the elastic or solid-like behavior of a material. G′ reflects the material's resistance to deformation and its ability to recover its original shape after deformation. Materials with a high G′ value are more elastic and tend to exhibit solid-like behavior.

G″ represents the loss modulus, which measures the viscous or liquid-like behaviour of a material, i.e. the proportion of the total rigidity of a material that is attributable to viscous flow, rather than elastic deformation.

A large value of G′ in comparison of G″ indicates pronounced elastic (gel) properties of the product being analyzed.

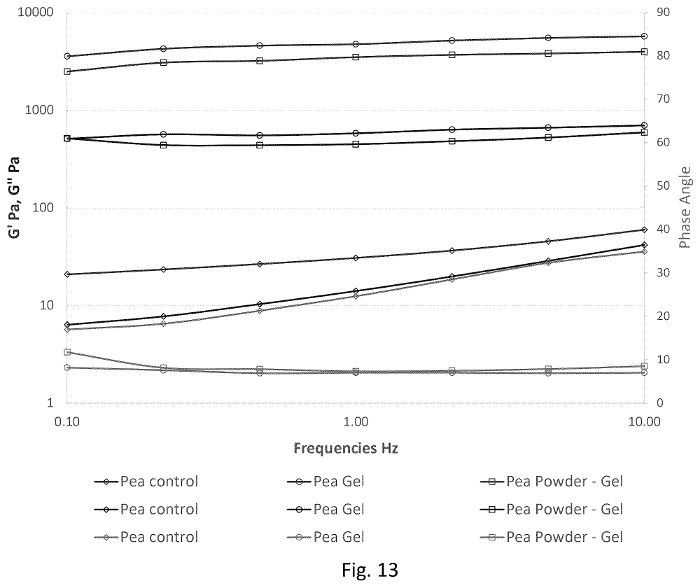

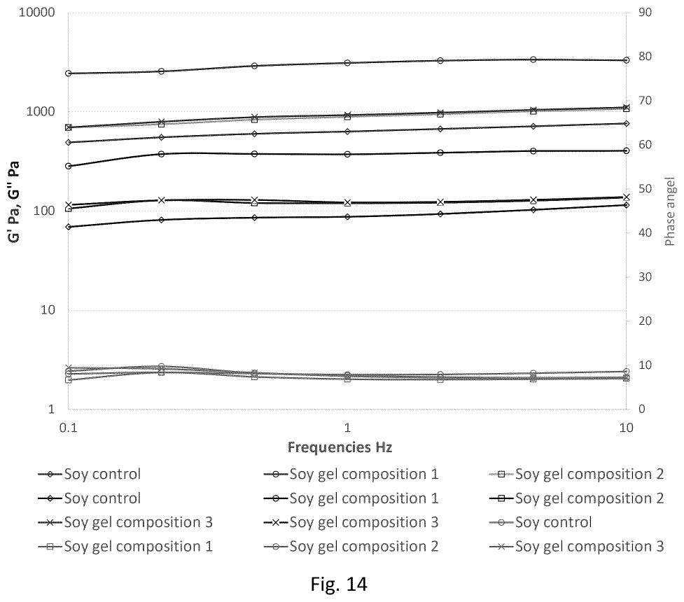

FIG. 13 shows the results of the oscillatory frequency response for the pea protein-based gels and FIG. 14 shows the results of the oscillatory frequency response for the soy protein-based gels, both exhibiting a typical frequency response for gels in oscillatory testing.

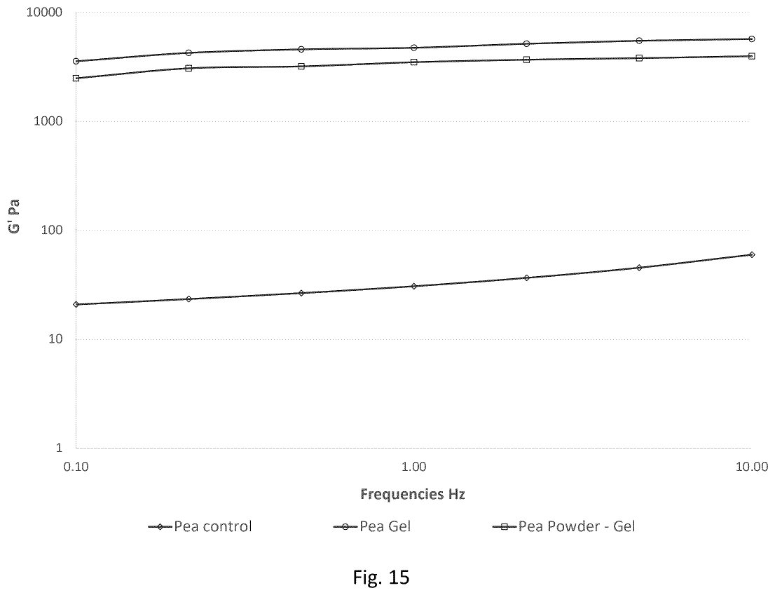

In addition, FIG. 15 shows that pea protein-based gels composed from the compositions of the invention advantageously have an energy storage module higher than that of the control. This storage module indicates that the strength of the inner small structure of the gels is higher than that of the control. The gels of the invention can store more energy in their structure and thus keep on its shape better than the control samples.

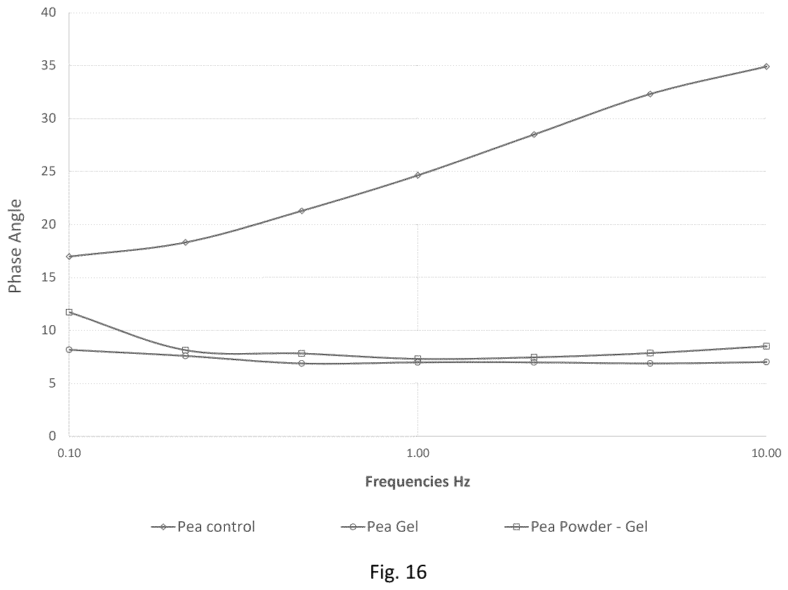

FIG. 16 shows the phase angle of the pea protein-based gels relative to the control. This figure indicates that the hydrogels exhibit a more “solid-like” behavior. Furthermore, FIG. 16 indicates that following frequency increase, the control sample lost its structure and exhibited a more “liquid-like” behavior, while the gels of the invention maintained their stable behavior.

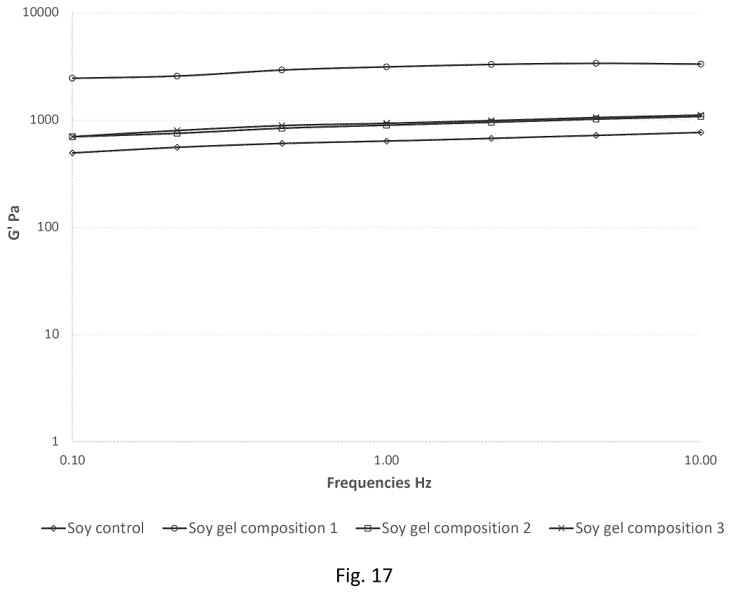

FIG. 17 shows that soy protein-based gels of the invention have a higher storage module, which indicates a strength of the inner small structure of the gels higher than the control. The gels can store more energy in their structure and thus advantageously maintain its shape better than the control samples.

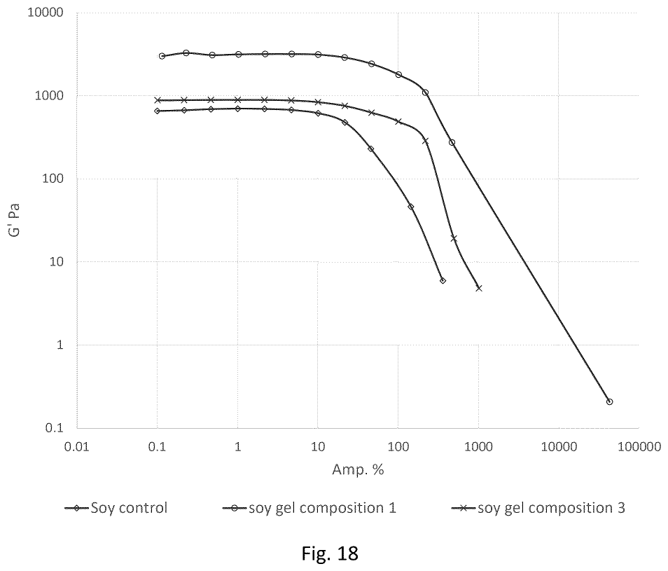

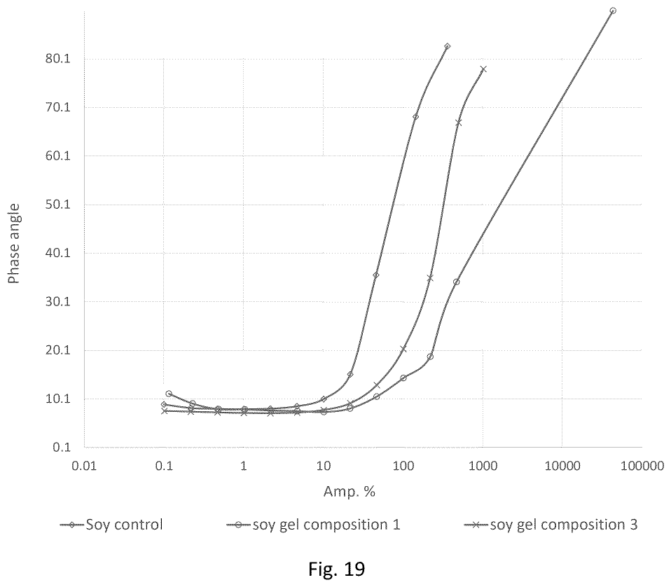

In order to test the stability of the inner structure of the soy protein-based gels relative to the soy control, additional oscillatory amplitude sweep tests were performed. The results are presented in FIGS. 18-19. As shown in FIGS. 18 and 19, the gels are more stable than the control and the control deforms earlier than the gels of the invention as the amplitude increases.

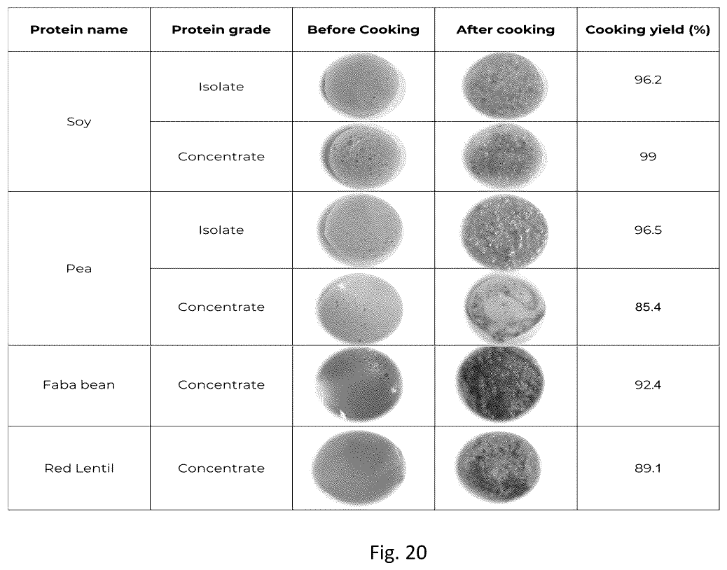

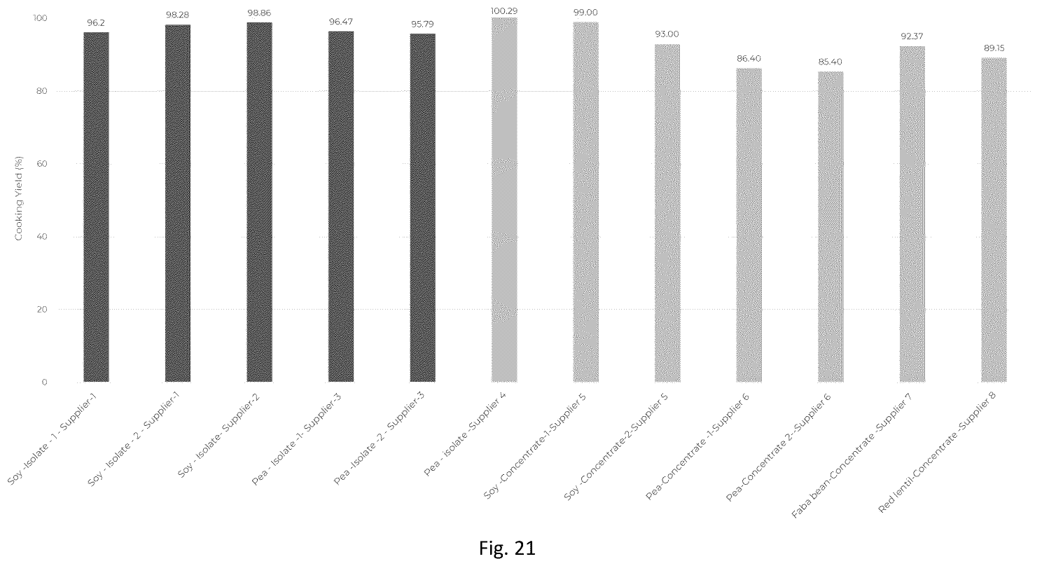

As shown by the above examples, the tested composition created stable gels having a stable texture suitable to food applications. FIG. 20 shows a table comparing the cooking yield percents of different plant-based protein (soy, pea, faba bean and red lentil) hydrogels made from enzymatically treated concentrate or isolate grade protein sources, along with their exemplary before and after cooking photos. As seen from FIG. 20, all plant-based protein (soy, pea, faba bean and red lentil) hydrogels showed a high cooking yield ranging from about 85-99%, which means that these hydrogels, whether concentrate or isolate protein-based, advantageously retain about 85-99% of their weight after baking. As shown in FIG. 21, similar results were obtained using same plant proteins from various suppliers.

FIG. 21 shows the cooking yield percents of various plant protein-based hydrogels, formed by using concentrate and/or isolate plant proteins (soy, pea, faba bean and red lentil), obtained from different suppliers (1-8) and treated as essentially disclosed herein.

As shown in FIG. 21, the herein disclosed protein-based hydrogels maintain a consistent and stable cooking yield percentage (about 85-99%), irrespective of the plant protein supplier and whether it was formed using a concentrated or isolated protein grade. This is especially advantageous for the herein disclosed concentrate plant protein-based hydrogels, as concentrate plant proteins are less processed, less expensive, more cost-effective, and readily accessible compared to the isolated plant protein.

### Example 6

### Preparation of a Stable Plant-Based Emulsion

The plant-based emulsion was prepared by mixing plant protein, here pea plant protein, with water (about 5-15% w/w protein)-. The protein water mixture was pretreated or left untreated, and an enzyme mixture comprising a crosslinking enzyme and a hydrolase. Following the enzymatic treatment, an edible fat or oil, was added to the composition. The type of fat/oil and the concentration of the oil/fat added depends on whether a water-in-oil (W/O) or an oil-in-water (O/W) is desired as further elaborated below.

Additional formulations including other proteins derived from other plant sources whether in the form of a concentrate or isolated proteins are prepared in a similar manner. Similarly, emulsion prepared using a hydrolase only for the enzymatic treatment are also prepared.

### Example 7

### Rheological Testing of the Emulsions

Emulsions prepared as described herein were tested by oscillatory tests in order to characterize their viscoelastic properties. The emulsions tested all include one or more crosslinking enzymes and one or more hydrolases. The tested emulsions were compared to control emulsions made from untreated polypeptides.

The oscillatory testing was done using a Netzsch Kinexus Pro +Rheometer at 25° C., with the following parameters: 40 mm roughened upper plate; 61 mm roughened lower plate.

The compositions tested all include one or more crosslinking enzyme and one or more hydrolase. The tested compositions were compared to control compositions prepared without treatment with crosslinking enzymes and hydrolases.

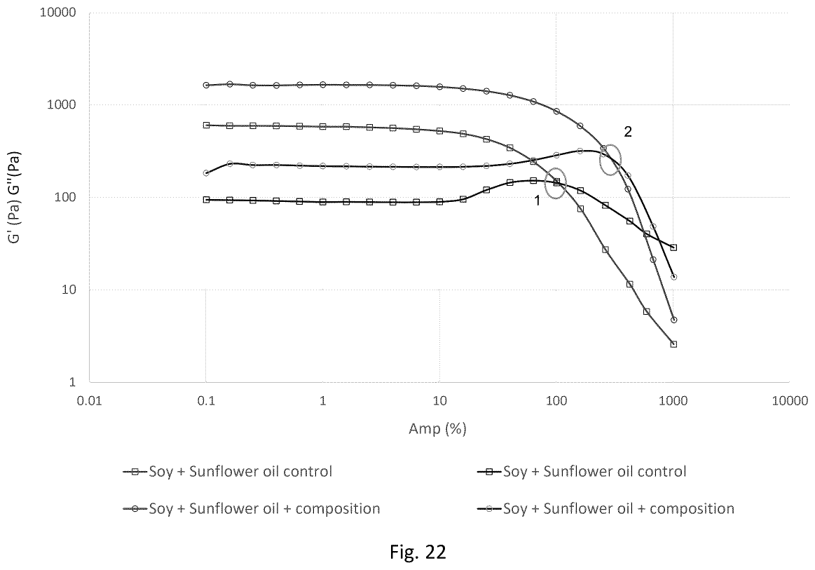

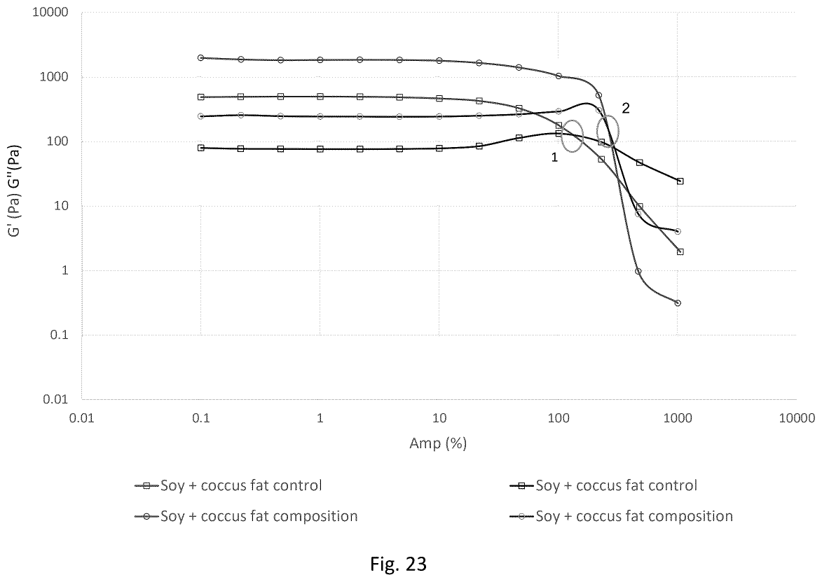

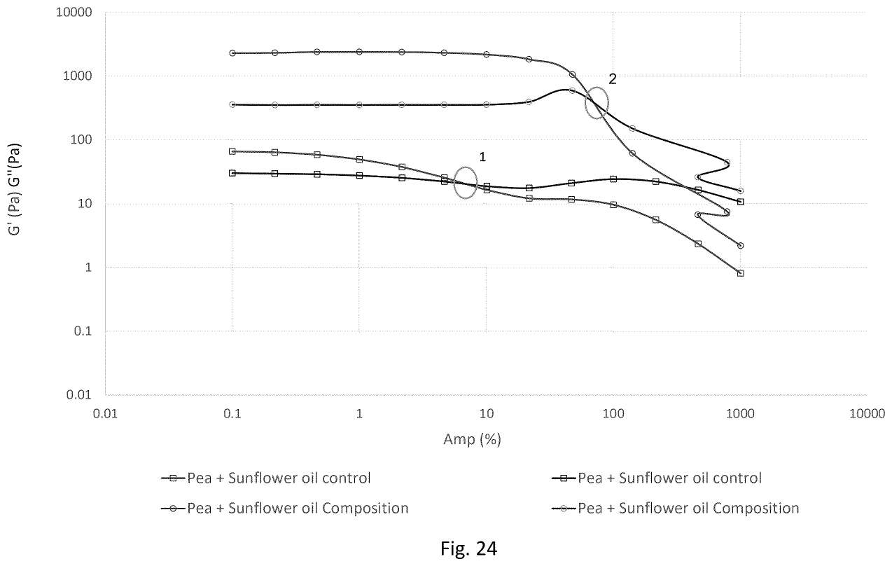

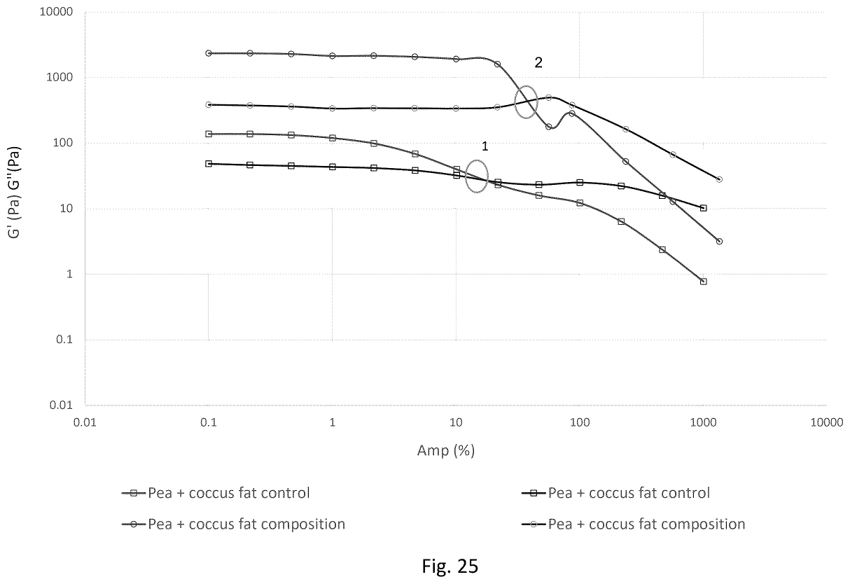

FIG. 22 shows the results of the oscillatory amplitude response for the soy protein-based emulsions made by mixing the herein disclosed soy protein based compositions with sunflower oil as compared to a control emulsion of soy protein and sunflower oil, FIG. 23 shows the results of the oscillatory amplitude response for the soy protein-based emulsions made by mixing the herein disclosed soy protein based compositions with coconut fat, as compared to a control emulsion of soy protein and coconut fat, FIG. 24 shows the results of the oscillatory amplitude response for the pea protein-based emulsions made by mixing the herein disclosed pea protein based compositions with sunflower oil, as compared to a control emulsion of pea protein and sunflower oil and FIG. 25 shows the results of the oscillatory amplitude response for the pea protein-based emulsions made by mixing the herein disclosed pea protein based compositions with coconut fat, as compared to a control emulsion of pea protein and coconut fat.

FIGS. 22-25 demonstrate that emulsion made with the herein disclosed compositions presents a more stable structure, and that the control emulsions deformed earlier than the emulsion including the herein disclosed composition. Moreover, emulsions including the herein disclosed composition had a higher storage module than the control emulsions, indicating the superior strength of the inner small structure of the soy or pea-based emulsions including the herein disclosed composition than the control. The soy or pea-based emulsion including the herein disclosed compositions can store more energy and thus maintain its shape.

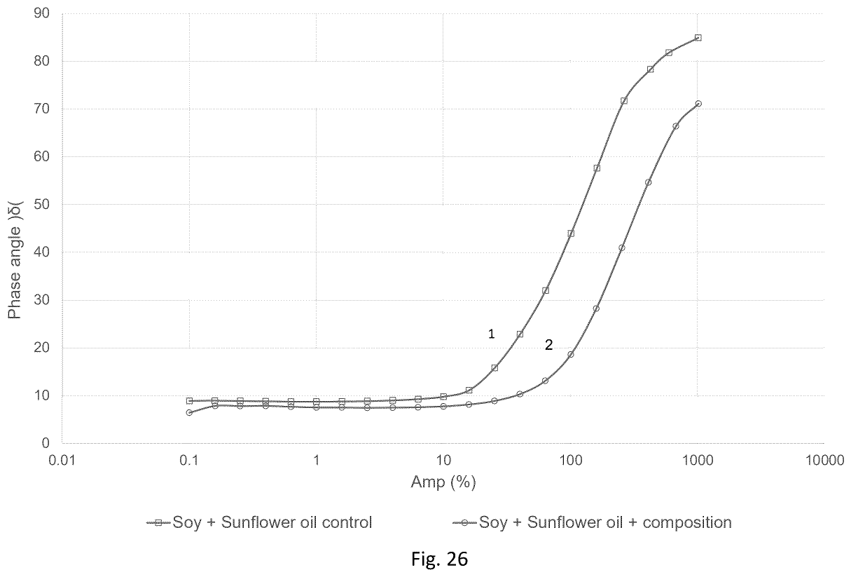

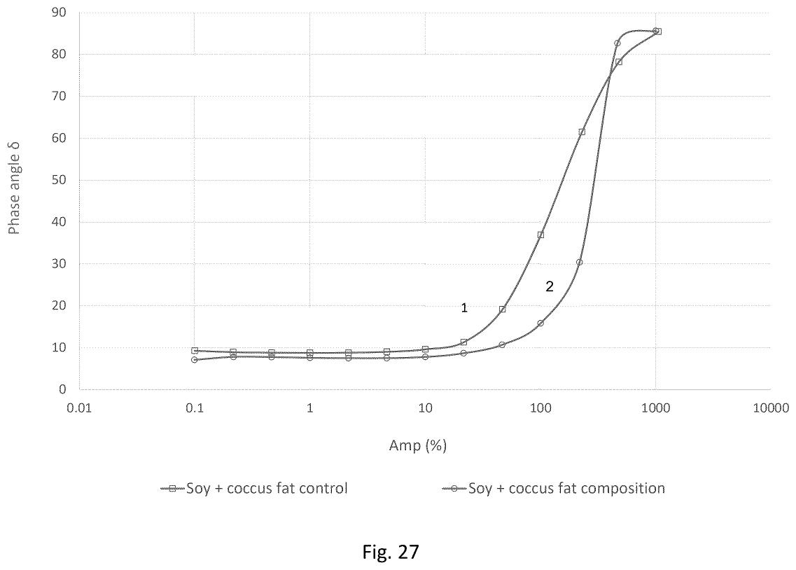

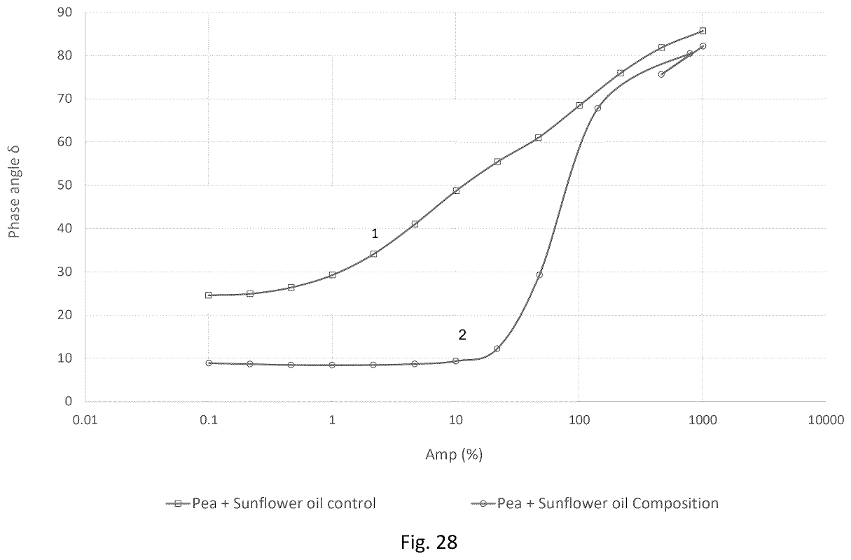

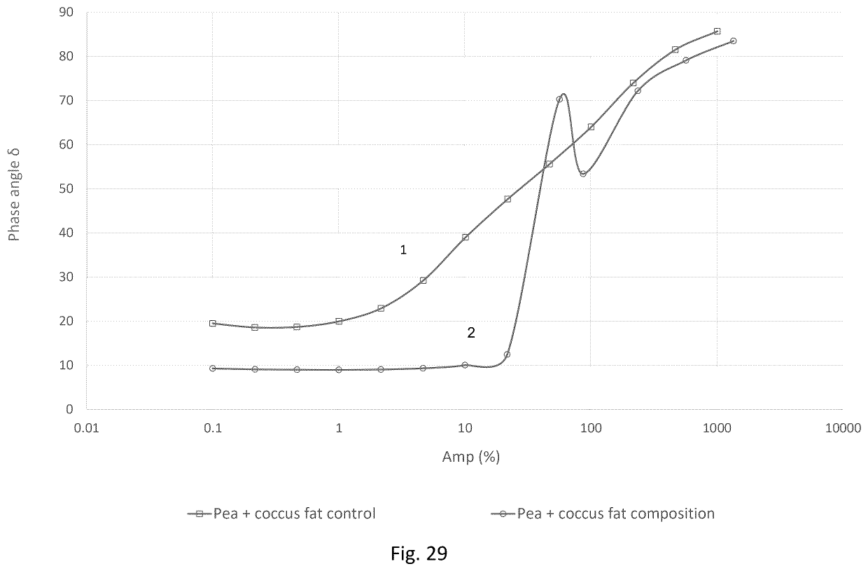

FIG. 26 shows the results of the oscillatory amplitude response for the soy protein-based emulsions made by mixing the herein disclosed soy protein based compositions with sunflower oil as compared to a control emulsion of soy protein and sunflower oil, FIG. 27 shows the results of the oscillatory amplitude response for the soy protein-based emulsions made by mixing the herein disclosed soy protein based compositions with coconut fat, as compared to a control emulsion of soy protein and coconut fat, FIG. 28 shows the results of the amplitude response for the pea protein-based emulsions made by mixing the herein disclosed pea protein based compositions with sunflower oil, as compared to a control emulsion of pea protein and sunflower oil and FIG. 29 shows the results of the oscillatory amplitude response for the pea protein-based emulsions made by mixing the herein disclosed pea protein based compositions with coconut fat, as compared to a control emulsion of pea protein and coconut fat.

As seen from FIGS. 26-29, during the amplitude increase, the control emulsions lost their structure and exabit a more “liquid-like” behavior than soy or pea emulsions including the herein disclosed composition.

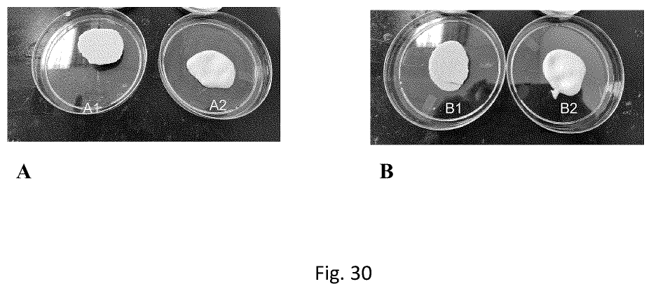

As further seen from FIG. 30, emulsions prepared using one or more crosslinking enzyme and one or more hydrolase (A1 pea protein and sunflower oil based composition; B1 pea protein and coconut fat based composition) advantageously maintained their strength when stored for two days, whereas control compositions prepared without treatment with the one or more crosslinking enzyme and the one or more hydrolase deformed and because more liquid like (A2 pea protein and sunflower oil control); B2 pea protein and coconut fat control).

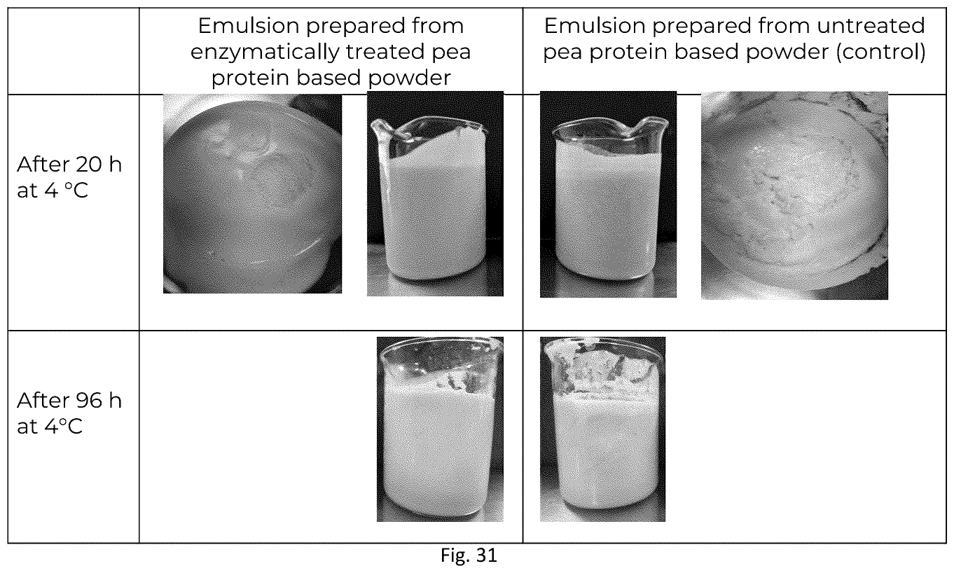

FIG. 31 shows exemplary photos of pea protein and coconut fat-based emulsion formed from a reconstituted powder (about 20% w/w fat) as compared to commercial pea protein and coconut fat-based control emulsion (without enzymatic treatment) (also with about 20% w/w fat), taken after 20 and 96 hours at 4° C. As shown in FIG. 31 a phase separation was seen in the control emulsion after 20 hours at 4° C. but advantageously was not seen in the herein disclosed pea protein and coconut fat-based emulsion from herein disclosed powder, even after 96 hours at 4° C. This indicates that pea protein and fat-based emulsions of the invention advantageously create more stable colloids that prevent the separation of oily and aqueous components better than the control emulsion.

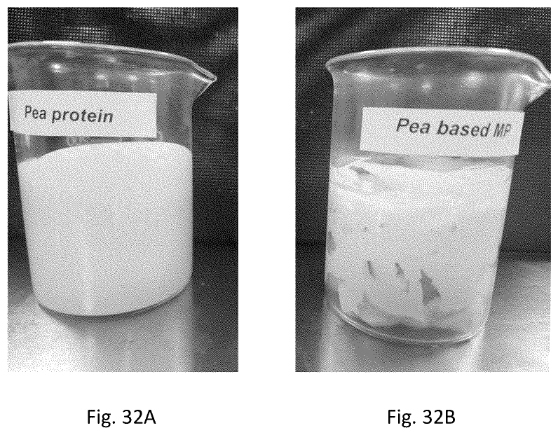

As further seen from exemplary photos in FIG. 32 the herein disclosed enzymatically treated composition can also form stable emulsions. Specifically, an emulsion made by mixing an enzymatically treated pea protein with about 60% w/w sunflower oil (FIG. 32a) was prepared and compared to a control emulsion (untreated proteins) (FIG. 32b). As seen from the figures, the emulsion prepared from the herein disclosed enzymatically treated plant proteins (here pea) generated a stable mayo-like emulsion as compared to the liquid control.

### Example 8

### Preparation of a Stable Foam

The plant-based emulsion was prepared by mixing modified plant protein powder, here treated pea protein powder (hydrolase and transferase) with water (about 3-15% w/w protein)-To obtain a foam, the composition was gradually whipped for 1 minute and then vigorously whipped for 10 min at a high shear speed (in a KitchenAid (KitchenAid, St. Joseph, MI) set at speed 6, until a stable foam was formed. After 30-minute at room temperature, a visual comparative analysis was conducted between the resulting foam, a foam made from untreated pea protein concentrate and albumen foam produced under identical whipping conditions.

Additional foam formulations including other proteins derived from other plant sources whether in the form of a concentrate or isolated proteins are prepared in a similar manner. Similarly, emulsion prepared using a hydrolase only for the enzymatic treatment are also prepared.

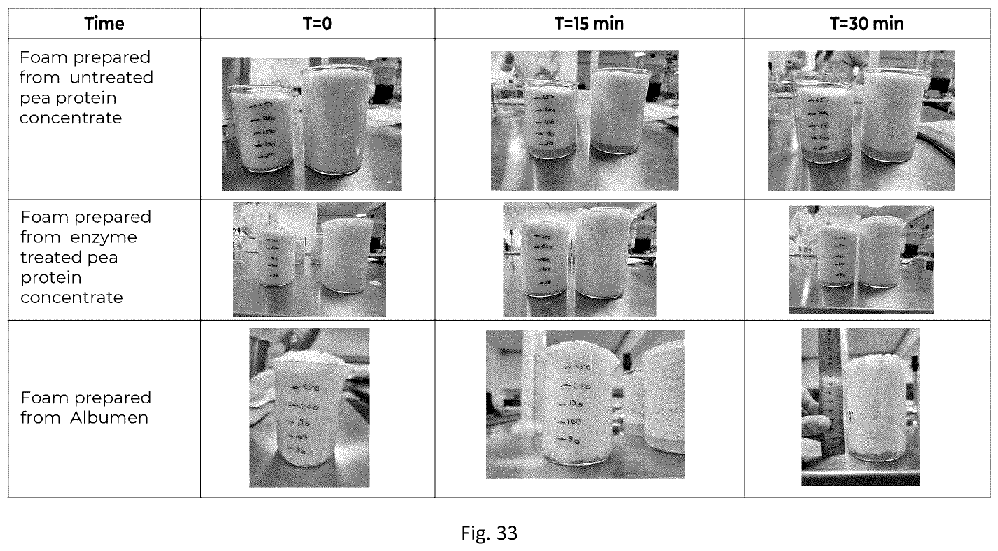

FIG. 33 shows exemplary photos of the herein disclosed pea protein-based foam, after 0, 15 and 30 minutes at room temperature, compared to albumen-based foam and commercial pea protein-based control foam (without enzymatic treatment), which were produced under identical whipping conditions. As seen from FIG. 33 After 15 minutes at room temperature, it was observed that the control foam exhibits a greater degree of phase separation compared to pea protein-based foam from powder, with approximately 40 mL and 10 mL of liquid settled at the bottom of the beaker, respectively. This trend persists after 30 minutes. Additionally, it is noted that the pea protein-based foam from powder and albumen-based foam displayed similar behavior, they demonstrated comparable phase separation after both 15 and 30 minutes, indicated by a similar volume of liquid settling at the base of the beaker. It can further be seen from FIG. 33 that pea protein-based foam from powder is more stable than the control foam, and as stable as albumen-based foam, under the specified conditions.

### Example 9

### Preparation of a Stable Foam Including Carbohydrates

The plant-based foam is prepared by mixing plant protein, for example soy, pea, sunflower, or chickpea plant protein, such as a protein derived from a plant source, with carbohydrate or polysaccharide, such as glucose, fructose, sucrose, or the like and with water (about 15-25% w/w protein, about 1-15 w/w % carbohydrate/polysaccharide).

The protein, carbohydrate and water mixture (dispersion) is homogenized. Hydrolases and oxidoreductases are added to the protein dispersion and incubated for about 30-60 min at about 40° C. The treated protein dispersion is vigorously whipped for 10 min. The resulting protein carbohydrate-based foam is compared to commercial pea protein and carbohydrate-based control dispersion (without enzymatic treatment). Foam capacity and foam stability is tested at room temperature and after baking.

### Example 10

### Quantifying the Concentration of Free Amino Acid Residues in Treated and Untreated Compositions

Amino acid extraction: suitable solvent for amino acid extraction (e.g., 0.1 m hcl) is prepared. Accurately measured amounts of sample are weighed into extraction tubes. Extraction solvent is added to the tubes in a ratio appropriate for efficient extraction. The mixture is sonicated or shaked.

To facilitate extraction of amino acids. The mixture is centrifuged to separate the supernatant containing extracted amino acids.

Quantification of amino acids: suitable method for amino acid analysis such as high-performance liquid chromatography (HPLC) or gas chromatography-mass spectrometry (GC-MS) is utilized.

Aliquots of the extracted samples and standards (of known concentrations for calibration) are injected into the chromatographic system. The amino acids are separated and quantified based on retention times and peak areas. The sample peaks are compared to standard peaks to determine amino acid concentrations.

Data Analysis: the concentrations of individual amino acids in the samples are calculated based on peak areas, and the amino acid concentrations between plant protein-based composition comprising enzymatically treated plant proteins as compared to plant proteins from a same source that are not treated enzymatically.

One skilled in the art readily appreciates that the present invention is well adapted to carry out the objects and obtain the ends and advantages mentioned, as well as those inherent therein.

The examples provided herein are representative of preferred embodiments, are exemplary, and are not intended as limitations on the scope of the invention.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1.-19. (canceled)

20. A composition comprising plant-derived polypeptides treated with a glycosidase and a crosslinking enzyme, wherein the composition is devoid of animal derived proteins and/or fats, wherein the composition is essentially devoid of artificial and synthetic stabilizers and thickeners, and wherein the composition is capable of forming hydrogels, and foams and/or emulsions.

21. The composition of claim 20, wherein the foams are stable for at least 5 min.

22. The composition of claim 20, wherein the emulsion are stable for at least 10 min.

23. The composition of claim 20, wherein the at least one crosslinking enzyme comprises at least one oxidoreductases and/or at least one transferase.

24. The composition of claim 23, wherein the oxidoreductase is a multicopper enzyme capable of oxidating phenolic residues.

25. The composition of claim 20, wherein the glycosidase is pectinase, a pectinmethylesterase, an amylase, an invertase, a cellulase or any combination thereof.

26. The composition of claim 20, wherein the plant-derived polypeptides are derived from soy, pea, corn, wheat, rice, nuts, almond, peanut, seitan, lentil, chickpea, flaxseed, chia seed, oat, buckwheat, bulgur, millet, sunflower, canola, legumes, pulses, tofu, tempeh, seitan, seeds, grain, chickpeas, lentils, legume, lupin, rapeseed, yeast, algae, microalgae, edamame, spelt, teff, hemp seeds, spirulina, amaranth, quinoa, leafy vegetables, oats, wild rice, chia seeds, fava bean, yellow pea, mung bean, nuts, protein-rich fruits and vegetables (such as broccoli, spinach, asparagus, artichokes, potatoes, sweet potatoes, brussels sprouts, sweet corn, guava, cherimoyas, mulberries, blackberries, nectarines, bananas), and combinations thereof.

27. The composition of claim 20, wherein the modified plant-derived polypeptides are from a dry fractionation product.

28. The composition of claim 20, being essentially devoid of methyl cellulose.

29. The composition of claim 20, wherein the composition further comprises at least one oil or fat.

30. The composition of claim 29, wherein the at least one oil or fat is selected from canola oil, olive oil, soy oil, sunflower oil, mustard powder oil, coconut oil, avocado oil, coconut fat, butter, and margarine.

31. The composition of claim 20, wherein the foam has a density of 0.1-0.7 g/cm³.

32. The composition of claim 20, further comprising one or more cofactors, vitamins, minerals or combination thereof.

33. The composition of claim 32, wherein the cofactor is selected from flavin, heme, thiamine, folic acid, metal ions such as iron, magnesium, manganese, cobalt, copper, zinc, and molybdenum, iron-sulfur clusters, etc., and combinations thereof.

34. The composition of claim 32, wherein is selected from vitamin A, vitamin C, vitamin D, vitamin E, vitamin K, choline, thiamin, riboflavin, niacin, pantothenic acid, biotin, vitamin B6, vitamin B12, folate/folic acid or any combination thereof.

35. The composition of claim 20, further comprising about 0.02 to about 0.08% w/w salt.

36. The composition of claim 35, wherein the salt is selected from sodium salts, potassium salts, calcium salts, magnesium salts and any combination thereof.

37. A food product comprising the composition of claim 20.

38. A method for preparation of a plant-based emulsion, the method comprising
a. mixing:
i. the composition of claim 20;
ii. water; and
iii. oil or fat; and
b. homogenizing or shear mixing the mixture of step a) to form an emulsion.

39. A method for preparation of a plant-based foam, the method comprising
a. mixing:
i. the composition of claim 20; and
ii. water; and
b. whipping the mixture of step a) to obtain a foam
